(19) United States
(12) Patent Application Publication
(10) Pub. No.: US 2018/0039951 A1
(43) Pub. Date: Feb. 8, 2018

(54) COMPUTER-ASSISTED AGENDAS FOR VIDEOCONFERENCES

(71) Applicant: Google Inc., Mountain View, CA (US)

(72) Inventors: Patrick WYNN, San Francisco, CA (US); Pui See Priscilla MOK, San Francisco, CA (US); Christopher JOHNSON, Alviso, CA (US); Ronald HO, Sunnyvale, CA (US)

(73) Assignee: Google Inc., Mountain View, CA (US)

(21) Appl. No.: 15/227,910

(22) Filed: Aug. 3, 2016

(51) Int. Cl. G06Q 10/10; H04N 21/4788; H04N 21/431; H04N 7/15

(52) U.S. Cl. CPC G06Q 10/1095; H04N 7/15; H04N 21/4788; H04N 21/4312

(57) ABSTRACT

Implementations relate to computer-assisted agendas for videoconferences. In some implementations, a computer-implemented method includes receiving, at a device, scheduling input associated with a videoconference, where the scheduling input includes a time for the videoconference and one or more identifiers of one or more participants for the videoconference. In response to receiving the scheduling input, the method generates a record of the videoconference in storage, and determines an agenda for the videoconference including a plurality of agenda items. Each agenda item is associated with a respective time period in the videoconference, and at least one of the time periods is automatically determined. The method detects that the videoconference is in progress, and in response, causes output during the videoconference on one or more participating user devices connected to the videoconference, where the output is based on at least one of the agenda items.

### BACKGROUND

The popularity and convenience of graphical displays and Internet communications have allowed videoconferencing to become widely used. For example, videoconferences implemented on various communicating devices can allow many users to see and hear each other from separated and remote locations. In some examples, interactive presentations, business meetings, casual gatherings, entertainment, and other social events can be held using videoconferencing technology to connect multiple participants in the events.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of the present application relate to computer-assisted agendas for videoconferences. In some implementations, a computer-implemented method includes receiving, at a device, scheduling input associated with a videoconference, where the scheduling input includes a time for the videoconference and identifiers of one or more participants for the videoconference. In response to receiving the scheduling input, the method generates a record of the videoconference in storage, and determines an agenda for the videoconference including a plurality of agenda items. Each agenda item is associated with a respective time period of a plurality of time periods in the videoconference, where determining the agenda includes automatically determining at least one of the time periods. The method detects that the videoconference is in progress, and in response to the detection, causes output during the videoconference on one or more participating user devices connected to the videoconference, where the output is based on at least one of the agenda items.

Various implementations and examples of the method are described. For example, the method can further include causing a user interface to be displayed on the device, and receiving agenda input in the user interface, the agenda input specifying at least one of the agenda items for the videoconference. The scheduling input can specify a time duration for the videoconference, and determining the agenda can include dividing the time duration of the videoconference into the plurality of time periods, and including determining an equal amount of time for each of the plurality of time periods within the time duration of the videoconference, where each agenda item is associated with a selected time period of the of time periods. The scheduling input can specify a time duration for the videoconference, and the method can further include receiving additional agenda input from the user adjusting a duration of at least one selected time period of the time periods associated with the agenda items, and automatically determining other time periods exclusive of the at least one selected time period, such that the other time periods do not overlap with the at least one selected time period and the other time periods are within the time duration of the videoconference.

The user interface can be configured to receive user input rearranging a sequence of the agenda items. The method can further include receiving videoconference content information to be presented during the videoconference, where automatically determining at least one of the time periods can be based at least in part on the videoconference content information to be presented during the videoconference. The method can further include estimating an amount of time for presenting the videoconference content information during the videoconference based on an analysis of the videoconference content information, and causing a display in the user interface of the estimated amount of time. The method can further include determining one or more priority levels associated with one or more of the agenda items, where automatically determining at least one of the time periods can include determining an amount of time for the at least one of the time periods based on the one or more priority levels associated with the one or more agenda items. Automatically determining at least one of the plurality of time periods can include determining a first amount of time for one or more time periods associated with one or more agenda items having a first priority level, and determining a second amount of time less than the first amount of time for one or more time periods associated with one or more agenda items having a second priority level lower than the first priority level.

The plurality of agenda items can include one or more suggested agenda items, where the at least one of the time periods is associated with at least one of the one or more suggested agenda items, and the method can include displaying the plurality of agenda items in the user interface. In some examples, the one or more suggested agenda items can be determined based on one or more prior agenda items used in one or more prior videoconferences in which the user participated, or based on one or more participant users designated to participate in the videoconference.

The method can further include providing a user selection control in a user interface, and receiving a selection of one or more selected participant users associated with one or more of the agenda items, wherein the selection is based on user input selecting the user selection control. The method can further include sending a notification to the one or more selected participant users indicating the association of the one or more user participants with the one or more associated agenda items. The output during the videoconference can include display of the agenda, where causing output during the videoconference can include causing a display of an indicator that indicates a current point of progress in the agenda, and the output during the videoconference can include one or more notifications of expiration of respective time periods of the agenda items during the videoconference.

In some implementations, a system includes a storage device and at least one processor configured to access the storage device and configured to perform operations including determining that a first device is connected to a videoconference as one of a plurality of participant devices connected to the videoconference over a network, where the first device provides a display of videoconference content information received over the network by the first device during the videoconference. The operations include obtaining data specifying an agenda, where the agenda includes a plurality of agenda items in a specified sequence and a respective time period allocated to each of the agenda items during the videoconference. The operations cause display, by the first device, of at least a portion of the agenda during display of at least a portion of the videoconference content information, and cause output by the first device during the videoconference of a notification associated with at least one of the agenda items at a time based on a time period associated with at least one agenda item.

Various implementations and examples of the system are described. For example, the processor can be further configured to perform operations including causing a display by the first device of an indicator that indicates a current progress point in the agenda for the videoconference, wherein the indicator indicates an indicated agenda item of the agenda items of the agenda; receiving user input during the videoconference indicating to change the current progress point in the agenda from the indicated agenda item to a different one of the agenda items; and causing a change of the display of the indicator to indicate the different agenda item. In some implementations, the notification can be output in response to a current time of the videoconference reaching a point in time that is within a threshold period of time before a start of a next agenda item after a current agenda item, where the notification indicates expiration of an active agenda item during the videoconference and/or approach of the next agenda item during the videoconference. The displayed agenda can include a graphical timeline that graphically indicates the agenda items.

In further examples of the system, the processor can be further configured to perform operations including receiving user input from a user of the first device to change one or more of the agenda items during the videoconference, causing an update to the agenda and the display of the agenda during the videoconference based on the user input, where the update is provided to the participant devices connected to the videoconference, and where causing an update to the agenda includes automatically adjusting one or more time periods of one or more of the agenda items not changed by the user input, such that the one or more of the agenda items not changed by the user input do not overlap the one or more agenda items changed by the user input. The processor can be further configured to perform operations including receiving and storing notes input by one or more users in the videoconference, and, in response to the videoconference disconnecting, sending the notes to users participating in the videoconference, where the notes are organized based on one or more agenda items active during which the notes were input.

In some implementations, a non-transitory computer readable medium can have stored thereon software instructions that, when executed by a processor, cause the processor to perform operations. The operations include receiving scheduling input from a device, the scheduling input associated with a videoconference, where the scheduling input includes a time for the videoconference and identifiers of one or more participants for the videoconference. The operations include, in response to receiving the scheduling input, generating a record of the videoconference in storage, and determining an agenda for the videoconference including a plurality of agenda items, where each agenda item associated with a respective time period in the videoconference. The operations include detecting that the videoconference is in progress, and, in response to the detection of the videoconference, causing output during the videoconference on one or more participating user devices connected to the videoconference, the output indicating active agenda items and upcoming agenda items of the agenda.

### BRIEF DESCRIPTION OF THE DRAWINGS

FIG. 1 is a block diagram of an example network environment which may be used for one or more implementations described herein;

FIG. 2 is a flow diagram illustrating an example method to determine an agenda for a videoconference, according to some implementations;

FIG. 3 is a flow diagram illustrating an example method to provide an agenda during a videoconference, according to some implementations;

FIGS. 4-9 are diagrammatic illustrations of example user interfaces including one or more described features to determine an agenda for a videoconference, according to some implementations;

FIGS. 10-11 are diagrammatic illustrations of an example user interface including one or more described features to provide an agenda during a videoconference, according to some implementations; and

FIG. 12 is a block diagram of an example device which may be used for one or more implementations described herein.

### DETAILED DESCRIPTION

One or more implementations described herein relate to computer-assisted agendas for videoconferences. In some implementations, a system can receive scheduling input associated with a videoconference. The scheduling input includes a time for the videoconference and identifiers of one or more participants for the videoconference. The system determines an agenda for the videoconference including a plurality of agenda items, each agenda item associated with a respective time period in the videoconference. For example, the agenda can be determined based on user input provided in a user interface, and can also include automatically-determined time periods and/or other parameters of one or more agenda items of the agenda. After determining the agenda, the system detects that the videoconference is in progress, and causes output on one or more participating user devices connected to the videoconference over a network, where the output is based on at least one of the agenda items during the videoconference.

Various additional features are described. For example, the scheduling input can specify a time duration for the videoconference, and the system can determine the time periods of the agenda items as having an equal amount of time and fitting within the videoconference duration. User input can adjust various parameters of agenda items, e.g., a duration of one or more agenda item time periods, and the system can automatically adjust the other time periods to fit the duration of the videoconference and/or adjust other parameters. The system can suggest one or more agenda items, including the automatic determination of time periods or other agenda item parameters. In some implementations, the suggestions can be based on videoconference content information provided to the system, such as slides, documents, or other information to be presented in the videoconference. Suggestions can also be based on other parameters of agenda items including priority levels for the agenda items and participant users of the videoconference who are associated with particular agenda items. Suggestions can also be based on prior agenda items of prior videoconferences. Notifications can be sent to designated participant users to indicate agenda items associated with those users.

The agenda, or portions of the agenda, can be displayed on participating devices during the scheduled videoconference. For example, one or more active agenda items can be displayed while videoconference content information is displayed as live images or video depicting participant users and/or other information such as slides, documents, etc. A graphical timeline of agenda items, and/or the current and next agenda items, can be displayed during the videoconference. Notifications can also be output to participating devices to indicate expiration of a current agenda item and/or when one or more next agenda items will become active. User input can change agenda item parameters during the videoconference, and the other agenda item parameters can be automatically adjusted to maintain a time duration within the scheduled videoconference duration. Notes input by participating users can be organized by the system based on the agenda and sent to participating users after the videoconference is ended.

One or more features described herein allow agendas to be flexibly provided in videoconferences. Suggested agenda items can be determined by the system automatically based on a variety of factors and provide accurate and useful estimates for timing and other parameters of agenda items for a particular videoconference. An agenda user interface allows a user to create and edit agenda items and any parameters of the agenda items including identifiers, order of agenda items, time periods, priorities, and associated participant users. Agenda item parameters that are not specified by user input can be automatically adjusted by the system based on user input and/or other data including user data (if user permission has been obtained), stored history of prior videoconferences, etc. This allows the agenda to provide an organized structure for the videoconference and remain within the videoconference duration and other specifications. Automatic display of agenda items and output of notifications during a videoconference provide assistance to users in conducting and in maintaining a particular organization of the videoconference. Agenda items can be flexibly edited by users during the videoconference to accommodate changes to the agenda made while the videoconference is in progress. Notes input by users during the videoconference can be organized and transmitted automatically by the system based on the agenda.

Described features can provide efficient determination and presentation of agendas for videoconferences. The determined agendas accurately provide estimated timing for presentation of subjects to be covered in the videoconferences. Described features can allow a device to determine and provide organized agenda information without significant time and processing requirements. Described techniques allow reduction or avoidance of extensive and tedious input by users of schedule and user information to schedule videoconferences, and reduction or avoidance of manual tracking and adjustment of time and schedules by users during a videoconference. Consequently, a technical effect of one or more described implementations is that organization and execution of videoconferences is reduced in computational time and resources expended to obtain results. For example, a technical effect of described features is a reduction in the problem of consumption of system processing resources required for extended videoconferencing time, additional videoconference sessions, and/or organization of associated data that may otherwise be required in a system that does not provide one or more of the described organizational videoconference features.

A videoconference as referred to herein can be any communication between participant users in which content data is transmitted from one participant's device to at least one other participant's device in the videoconference over a communication network. For example, a videoconference can be a video chat, text chat, or teleconference enabled on devices with displays. The transmitted content data can include live captured images or video depicting one or more participant users, and/or audio capturing the speech of participants. The transmitted content data can include other presented data including slides, documents, stored images, videos, or audio, etc. The image data can be a still image or can be video data, e.g., images included in a series of images, frames in a video sequence of video frames, or images in a different type of sequence or collection of images. An image can be a still image, a panoramic image, a three-dimensional (3D) capture (e.g., spherical image), or other form of image. For example, a single image may be an aggregation or combination of multiple “sub-images” captured near in time and/or space.

One or more systems and methods discussed herein do not require collection or usage of user personal information. In situations in which certain implementations discussed herein may collect or use personal information about users (e.g., user data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

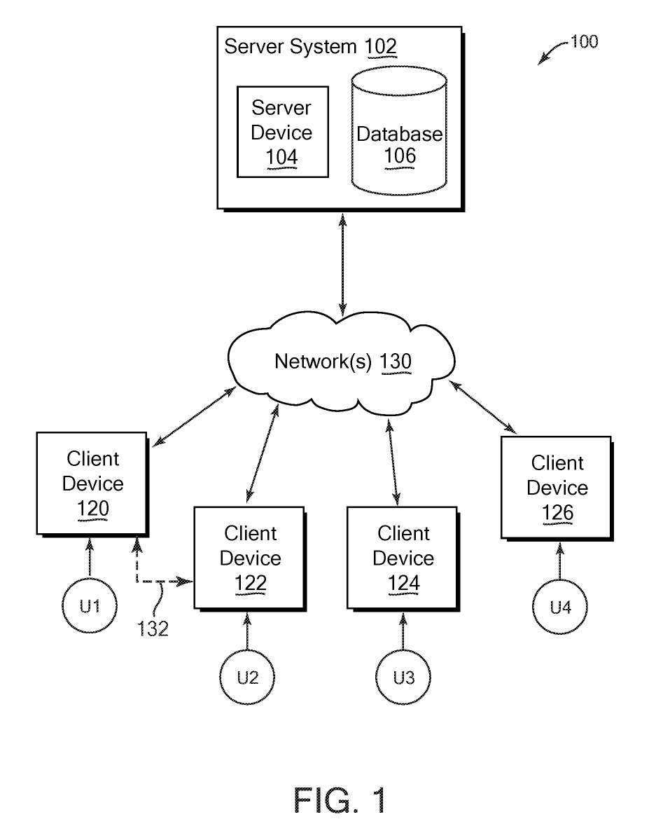

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., a desktop computer, laptop computer, portable or mobile device, cell phone, smart phone, tablet computer, television, TV set top box or entertainment device, wearable devices (e.g., display glasses or goggles, wristwatch, headset, armband, jewelry, etc.), personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some example implementations, users U1, U2, U3, and U4 may interact with each other via applications running on respective client devices and/or server system 102. In some implementations, the interaction may be performed via a network service, e.g., a social network service or other type of network service implemented on server system 102. For example, respective client devices 120, 122, 124, and 126 may communicate data to and from one or more server systems (e.g., server system 102). In some implementations, server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, video, audio, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, video sequences, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, video data, and other content as well as communications, privacy settings, notifications, and other data on a client device 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, such as one or more display screens, projectors, etc. In some implementations, application programs running on a server system can communicate with a client device to receive user input at the client device and to output data such as visual data, audio data, etc. at the client device.

In some implementations, server system 102 and/or one or more client devices 120-126 can provide a scheduling application and/or a videoconferencing application. The videoconferencing application may allow a device to connect to videoconferences, e.g., connect to one or more other participant devices in a videoconference. The application can allow a device to output various data, e.g., display video, images, text, and other data and output audio received by the client device running the application, where the video, images, and audio can be captured during the videoconference or retrieved from storage by one or more participant devices. The videoconferencing application can provide an associated user interface that is displayed on a display device associated with the server system or client device. The user interface may provide various display functions (e.g., display modes) for videoconferences and other communications. In some implementations, the user interface can receive scheduling input and agenda input (e.g., based on user input) that schedules one or more videoconferences and agendas as described herein. Some implementations can provide videoconferencing scheduling functions in a separate application.

Other implementations of features described herein can use any type of system and/or service. For example, photo collection services or other networked services (e.g., connected to the Internet) can be used instead of or in addition to a social networking service. Any type of electronic device can make use of features described herein. Some implementations can provide features described herein on client or server devices disconnected from or intermittently connected to computer networks. In some examples, a client device including or connected to a display device can process and display data stored on storage devices local to the client device (e.g., not connected via a communication network) and can provide one or more features and results as described herein that are viewable to a user.

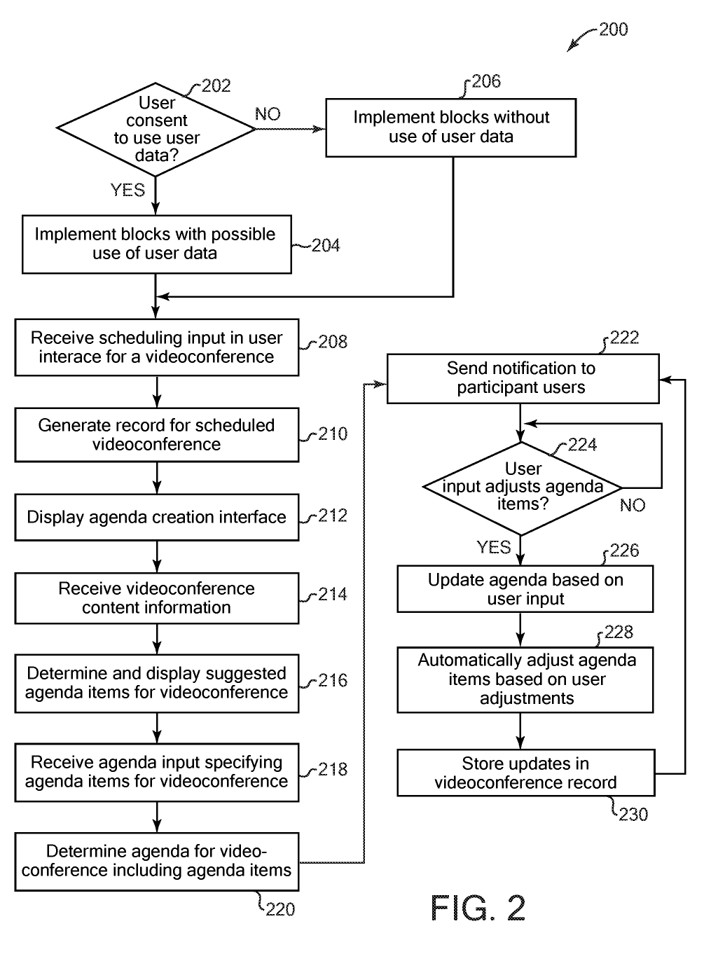

FIG. 2 is a flow diagram illustrating one example of a method 200 to determine an agenda for a videoconference. In some implementations, method 200 can be implemented, for example, on a server system 102 as shown in FIG. 1. In other implementations, some or all of the method 200 can be implemented on a system such as one or more client devices 120, 122, 124, or 126 as shown in FIG. 1, and/or on both a server system and one or more client systems. In described examples, the implementing system includes one or more processors or processing circuitry, and one or more storage devices such as a database 106 or other storage. In some implementations, different components of one or more servers and/or clients can perform different blocks or other parts of the method 200.

Videoconference content information as described herein can include video data, where the video data includes frames that are digital images composed of multiple pixels, for example. Videoconference content information can include one or more still images. An image as described herein can be received over a network in a videoconference, or can be sent over the network from one or more storage devices of the implementing system or storage otherwise accessible to the system, such as a connected storage device, e.g., a local storage device and/or storage device connected over a network. In various implementations, images can be obtained from a variety of sources. Images may be obtained as captured images from a camera during a videoconference, or as uploads by a user to a server over one or more networks, from an album or other stored collection of videos and/or images owned or accessible by a user, etc. Videoconference content information can also or alternatively include audio data, text data, and other data transmitted between participating devices in a videoconference as described herein.

In block 202, it is checked whether user consent (e.g., user permission) has been obtained to use user data in the implementation of method 200. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use such user data in some implementations. If user consent has been obtained from the relevant users for which user data may be used in the method 200, then in block 204, it is determined that the blocks of the methods herein can be implemented with possible use of user data as described for those blocks, and the method continues to block 208. If user consent has not been obtained, it is determined in block 206 that blocks are to be implemented without use of user data, and the method continues to block 208. In some implementations, if user consent has not been obtained, the remainder of method 200 is not performed.

In block 208, scheduling input is received by the device, e.g., in a displayed user interface, to create and specify a scheduled videoconference. In some implementations, the user interface can be displayed by a user device used by a user who wishes to schedule a videoconference (the “scheduling user”). The user interface can be displayed on a display device of the user device, e.g., display screen(s) or other type of display. Some examples of a scheduling user interface are described below with reference to FIG. 5.

In various implementations, the user interface can be displayed by a videoconferencing application running on the user device, or by a different application. For example, some implementations can provide an integrated computing environment in which one or more applications can communicate with and send data to each other, such as a productivity suite including word processor application, spreadsheet application, email, messaging, social networking, and other communication applications, slide presentation application, graphical presentation application, image editing application, etc. One or more of such integrated applications can access and display a common user interface for scheduling a videoconference. For example, the scheduling interface can receive data from the applications, including videoconference content information created or edited by the applications (e.g., documents, slides, spreadsheets, images, audio files, videos, etc.), user data (if user consent is obtained) input in the applications (e.g., user comments, ratings, etc.), and other data. Such data can be used to determine suggested agenda items and other scheduling parameters, and/or can be presented during the scheduled videoconference as videoconference content information, as described below. In some implementations, multiple users can be using the applications of such a productivity suite, and the scheduling interface can obtain data from the applications currently used by a set of users to determine a scheduled videoconference, where the set of users can be, e.g., users in a designated group, users editing a particular document or presentation, etc. The scheduling interface can, in some implementations, start a videoconference immediately upon user command based on videoconference parameters determined based on such currently-running applications and content information currently viewed or edited in the running applications. In one example, if users cannot resolve an issue that has arisen on a shared document that they are currently working on, then a videoconference can be initiated between the users using an integrated user interface. The videoconference can present the shared document as videoconference content information, and can include suggested agenda items based on data from the document, as described below.

In some examples, the scheduling input (and other user input) can be provided by the scheduling user, e.g., via an interface device of the user device such as a touchscreen, pointer device (mouse, joystick, etc.), microphone and software to recognize voice input, etc. In some examples, the scheduling input can be entered into displayed input fields or other graphical objects or indicators in the user interface which have been specifically related to videoconferencing parameters and features described herein. For example, scheduling input can include selections by user input of one or more items in a menu, one or more displayed user interface elements, text or graphical objects, etc. In some implementations, the scheduling input can be obtained from a storage device accessible by the user device, e.g., local or remote storage. For example, obtained scheduling input can be displayed in particular input fields or other areas of the user interface.

The scheduling input can specify parameters of the videoconference. For example, the scheduling input can specify a start time for the videoconference. The start time can be specified as a time of day on a particular date, or can be specified as a recurring time of day, e.g., every Tuesday, every 15th day of each month, etc. In addition, the scheduling input can specify a time duration for the videoconference. For example, the duration can be specified in hours, minutes, seconds, etc. In some implementations, a time duration can be specified as ongoing, e.g., the videoconference will continue indefinitely until a participant (e.g., one or more specified participants) provides a command to end the videoconference. In some implementations, the videoconference time duration can be specified based on one or more events. For example, the time duration can be based on videoconference content information provided by the scheduling user (or provided by a designated participant user of the videoconference). In some examples, a time duration can be estimated by method 200 based on all the videoconference content information to be presented at the videoconference, e.g., a number of slides, a length of a presented document, a number of participant users to speak at the videoconference, etc.

The videoconference parameters can include designations of a number of participants (e.g., participant users) who are to participate in the videoconference. For example, particular names of users (e.g., user names), addresses of users (e.g., email address or other network address, account name, etc.), titles within an organization (e.g., titles or positions within a company, etc.) or other user identifiers can be specified by the scheduling input. Some implementations can allow one or more designated participants to be non-user entities. In some examples, a designated participant can be a group or organization, a device (e.g., a computer device, videoconference camera or other communication device, etc.), a location (e.g., a location at which one or more users who are present at the location can view and receive the videoconference, such as a particular conference room having videoconference I/O components and designated with an identifier), a virtual machine residing on a device, etc. For example, the scheduling input can be specified via data entry (e.g., input text), selected items from a displayed menu (e.g., selected user names), etc. In various implementations, the scheduling user can be automatically designated as a participant user, or can be designated as a participant user based on the scheduling input.

Some implementations can designate one or more titles or subjects for the videoconference as a parameter. For example, a subject of “product release meeting” can be provided for the scheduled videoconference to indicate the subject of the videoconference. In some implementations, one or more subjects can be automatically determined for the videoconference based on videoconference content information, e.g., received in block 214. For example, a title of a first slide, document, heading of a document, filename of a content file, or other name, identifier, or title in the videoconference content information can be automatically determined by method 200 as a suggested subject for the videoconference.

In block 210, a data record of the videoconference is generated. For example, a data structure can be created and stored in one or more storage devices accessible to the user device. The videoconference parameters determined in block 208 can be stored in the videoconference record.

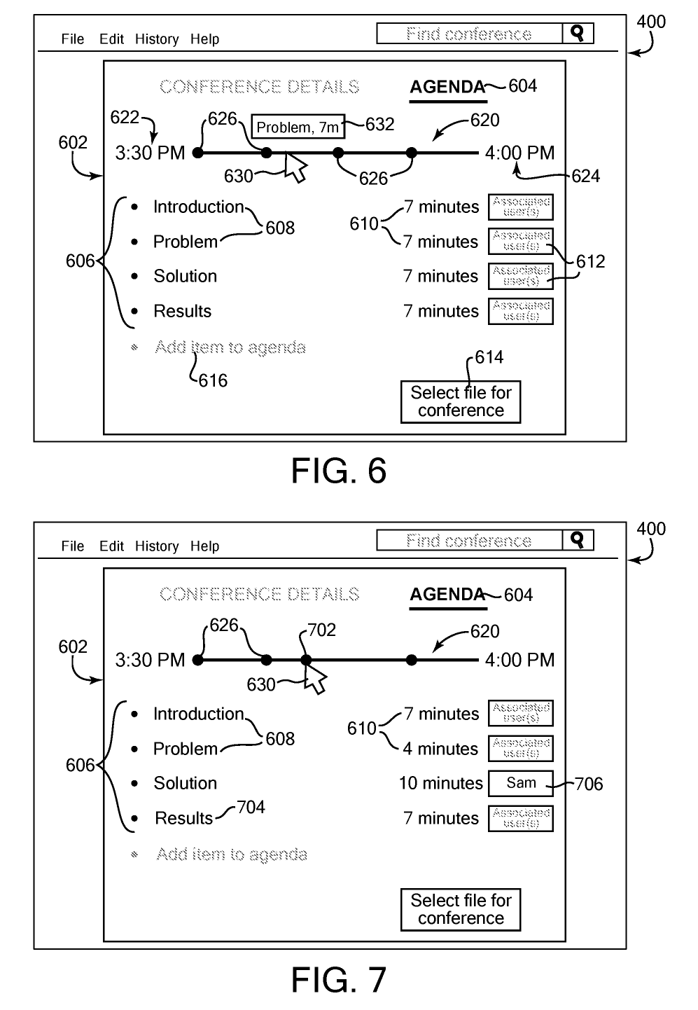

In block 212, an agenda creation interface can be displayed. For example, user input can cause the agenda creation interface to be displayed if the scheduling user wishes to create an agenda for the videoconference scheduled in blocks 208 and 210. In some implementations, the agenda creation interface can be included in the user interface displayed in block 208. The agenda interface can include various input fields, controls, and other displayed items related to agenda creation and review as described herein. Some examples of an agenda creation interface are described below with reference to FIGS. 6-8.

The agenda creation interface can be used to create an agenda for the created videoconference, which is a specified list of agenda items designated to be covered during the videoconference, e.g., subjects, topics, or other information to be discussed, presented, or otherwise covered by the participants during the videoconference. Each agenda item can include one or more parameters. Some example agenda item parameters described herein include an identifier (e.g., name of the agenda item), rank or order (e.g., first, last, or some other position in the agenda item order or list), time period duration, priority level, one or more associated participant users of the videoconference (e.g., a user associated with a particular agenda item can indicate that the user will present information for the agenda item during the videoconference), etc. In some implementations, the agenda creation interface can include a number of input fields or other indicators that allow a user to input one or more parameters of the agenda items included in the agenda for the videoconference.

An agenda includes multiple agenda items and multiple time periods allocated within the duration of the videoconference, where each agenda item can be associated with a different one of the time periods. For example, a first time period of a first agenda item can be designated, followed by remaining agenda items in successive time periods following the first agenda item time period. In some implementations, each successive agenda item time period immediately follows the preceding agenda item time period. In some implementations, agenda items may be associated with time periods that have gaps of time between them within the videoconference duration. For example, after a first agenda item is concluded during a videoconference session, a gap of 10 minutes may proceed in which no agenda item is associated with that gap of time, and a next agenda item of the agenda is then started after that gap of time has concluded. Some implementations can provide agenda items at different hierarchical levels, so that an agenda item may be considered to be a parent of one or more child agenda items (or sub-agenda items) grouped within the parent agenda item, one or more of those child agenda items may have next-level child agenda items grouped within them, and so on. In one example, a parent agenda item may have a label associated with a general topic or category (e.g., “Financial Department Presentations,”) and each child agenda item of that parent agenda item can be associated with a more specific topic or category included within that general topic or category (e.g., “Accounting,” “Sales,” “Marketing,” etc. as topics included in the “Financial Department Presentations” category).

In block 214, videoconference content information can be received in some cases or implementations. The videoconference content information can include presentation content information that is to be transmitted to one or more participant devices during the videoconference, e.g., presented for display by participant devices to associated participant users. For example, in some implementations the videoconference content information can be uploaded to a server or other device that will be handling the videoconference. The videoconference content information can include, for example, text, one or more videos or images, audio data, one or more slides or documents (e.g., providing various topics or subjects related to the videoconference) including text, images, video, animations, diagrams, audio, and/or other types of media for presentation, a program to allow interaction from one or more participants (e.g., in an interface communicated to and displayed on participating devices during the videoconference), or other information to be communicated and/or presented during the videoconference. In some examples, the videoconference content information can include a document such as a script or description of dialogue to be spoken during the videoconference, and/or ordered subjects or topics having particular users associated with particular portions of the document, e.g., participant users that are designated to present those portions during the videoconference.

In block 216, one or more suggested agenda items may be determined and caused to be displayed in the agenda creation interface in some implementations. A suggested agenda item can include one or more suggested agenda item parameters (e.g., identifier, order, priority, associated participant user(s), and/or time period duration). For example, suggested parameters for the suggested agenda items can be displayed in input fields or other areas or portions of the interface that display the agenda items. In some implementations, a list of suggested agenda item parameters can be displayed in the interface, where the user can select one of the listed suggested agenda items. For example, such a list can be displayed in response to the scheduling user inputting one or more initial letters in the input field that match the same initial letters of the suggested agenda items on the list. Some implementations can display an overall list of suggestions from which the user can select to specify one or more parameters for particular agenda items. In some implementations, suggested agenda items can be displayed having a different visual appearance than agenda items input or modified by the user, e.g., a different font, color, size, etc. For example, suggested agenda items can be displayed in a half-tone text or grey color text, in contrast to darker text or brightly-colored text used for user-specified agenda items.

Suggested agenda items, or one or more parameters of the suggested agenda items, can be automatically determined (e.g., without user intervention) by the system implementing method 200 or other connected system, based on one or more factors.

In some implementations, the factors can include default or predetermined agenda items that can be provided in a standard configuration. For example, particular suggested agenda items can be associated with particular positions in a sequence of agenda items. In some examples, an agenda item labelled “Introduction” can be automatically assigned to a first agenda item in a first time period of the agenda, and/or an agenda item labelled “Wrap-up” or “Conclusion” can be automatically assigned to a last agenda item of the agenda. The time period durations, priorities, and/or other parameters assigned to these suggested agenda items can also be predetermined. For example, the “Introduction” suggested agenda item can be assigned a default time period duration of 3 minutes, and the “Wrap-up” agenda item can be assigned a default time period duration of 2 minutes. Some implementations can determine default agenda item parameters based on videoconference parameters. For example, a default duration parameter for the duration of suggested agenda items can be determined as a particular percentage of the videoconference duration. In one example, the time period duration of the “Wrap-up” suggested agenda item can be determined as 5% of the total videoconference duration.

In some implementations, the default time period durations of agenda items can be determined to be equal to each other, e.g., where the total videoconference duration is divided by the number of agenda items to determine the duration of each agenda item. Such default time period durations and other parameters can be modified by other factors, e.g., priorities as described below.

Some implementations can select one of multiple stored agenda templates that can be available for different types of videoconferences. In some examples, an agenda template can be a data structure providing particular information related to an agenda. Each agenda template can include a set of suggested agenda items for the type of videoconference associated with that template, allowing a particular set of suggested agenda items to be assigned to the videoconference. For example, a videoconference intended for a business meeting can use a business agenda template that includes a set of commonly-used suggested agenda items suitable for business functions, and a videoconference used for reading a play or movie script can use a script agenda template that includes a different set of suitable agenda items. The type of videoconference and template can be explicitly selected (e.g., by the scheduling user in an interface), or the type can be determined automatically by the system by examining associated data (if user consent has been obtained), e.g., participant users (titles, organization, etc.), videoconference content information (detecting particular keywords, images, etc.), time and/or geographic location of the videoconference and/or participant users, or other related data.

Another factor that can be used to determine suggested agenda items can be one or more prior agendas and/or agenda items that have been used in prior videoconferences and stored in accessible storage (if user consent has been obtained to access such prior data). Some prior videoconferences can be explicitly linked or connected to the created videoconference, e.g., by a user designating a link or reference to a prior videoconference. Some prior videoconferences can be determined by the system to be eligible to provide suggested agenda items based on particular factors. For example, the system performing method 200 can determine whether one or more prior videoconferences have been scheduled at similar times to the time of the created videoconference scheduled in block 208. If there is a common occurrence (e.g., over a threshold number of occurrences) of agenda items that were used in such prior videoconferences (e.g., used during the videoconference after all user edits to the agenda), then one or more prior agenda items of these prior videoconferences can be used as suggested agenda items for the created videoconference. In some examples, the system can determine that a prior videoconference was scheduled and held for the last 3 months at the same time of day and day of week that the created videoconference is scheduled, and that in a threshold number (or a threshold percentage) of prior videoconferences, particular agenda items were the same in particular time periods of the prior videoconferences. The system can provide those same agenda items as suggested agenda items for the same time periods of the created videoconference as in the prior videoconferences. Some implementations can check for similar user participants of prior videoconferences as in the created videoconference, e.g., the same or similar group of participants, such that prior videoconferences having a threshold amount or percentage of the same user participants will be considered for suggested agenda items. For example, prior videoconferences having 50% of more of the same user participants as the created videoconference can be examined to obtain suggested agenda item information for the created videoconference.

Some implementations can check for similar titles or subjects of the prior videoconferences to the created videoconference and use prior agenda items from the prior videoconferences having the same or similar title to the created videoconference (e.g., similar semantically as based on dictionary or knowledge base comparisons). In some further examples, a prior agenda item of a prior videoconference may have been associated with a particular participant user, and if that same participant user has been designated to participate in the created videoconference, the prior agenda item can be included in the agenda as a suggested agenda item. In some implementations, the system can display agenda items that have appeared in prior videoconferences as suggested agenda items, e.g., in a displayed list, and can let the scheduling user designate a particular order and/or time period durations in the agenda for these suggested agenda items.

In some implementations, prior agenda items of prior videoconferences can be examined by the system to determine a more balanced allocation of time period durations for suggested agenda items (and other agenda items) of the created videoconference. For example, if it is determined from prior agenda items that more time was allocated to and/or used by a particular business group or participant user in prior videoconferences, the system can compensate by determining more time for other business groups or participant users in the suggested agenda items of the created videoconference. In some implementations, historical videoconference information (e.g., prior videoconferences, prior agenda items, and/or logged changes to the agenda items made by participant users during the prior videoconferences) can be examined to determine if particular agenda items were extended in time. For example, it may be determined from stored, logged data that more time was used for particular agenda items during a threshold number of previous videoconferences. The system can then accordingly increase the time period durations for corresponding particular suggested agenda items in the created videoconference. Other characteristics of prior similar videoconferences, or trends in a history of prior similar videoconferences, can be examined to determine parameters of suggested agenda items for the scheduled videoconference.

Another factor that can be used to determine suggested agenda items can be videoconference content information, e.g., videoconference content information received in block 214 to be presented at the created videoconference, or prior videoconference content information presented in one or more prior videoconferences. Different sections of the videoconference content information can be delineated and can be associated with respective suggested agenda items. For example, a document or set of slides that are received based on commands from the scheduling user for presentation during the created videoconference can be examined by the system to obtain particular topic or subject headings for different sections (e.g., as indicated by section numbers in a document, underlined or bolded text, text having a larger font size, text designated by associated metadata as headings, etc.), and such headings can be provided as the identifiers for suggested agenda items in some examples. In another example, each designated scene in a received script document can be assigned a respective agenda item in the agenda. In some implementations, these suggested agenda items can be provided in the same order (sequence) as the sections appear in the videoconference content information, e.g., the sequence of headings, scenes, slides, or pages of the content.

Some implementations can determine one or more suggested agenda items based on content information that may not be used (and/or may not have been previously used) as videoconference content information, if user consent has been obtained from the associated users to access such content information. For example, the other content information can be documents, images, or other content data associated with one or more participants of the scheduled videoconference and/or with the scheduling user. In some examples, text analysis and recognition techniques, image detection and recognition techniques, and other techniques can be used to analyze content information to determine keywords, phrases, related topics and categories (e.g., as determined from an accessible knowledge base, databases, dictionaries, etc.), and other content which can be used in suggested agenda items. In some further examples, one or more agenda items that have been specified (e.g., in previous videoconferences or by the scheduling user in the scheduled videoconference in block 218) can be analyzed, and associated or related agenda item parameters can be determined and suggested for other agenda items not yet specified by the scheduling user. Some examples are described below with reference to block 218.

Some implementations can determine the respective time period durations of the suggested agenda items based on the videoconference content information. For example, the amount of content included in a particular section (e.g., heading, scene, etc.) in the videoconference content information can be used as a basis for the time period duration of the associated suggested agenda item. In some examples, the amount of content (e.g., amount of text or images, number of slides or pages, etc.) in a particular section, as a percentage of the total amount of content in the videoconference content information, can indicate a proportional or percentage amount of time duration for the corresponding suggested agenda item. In one example, if the scheduling user uploads a slide presentation of 40 slides as videoconference content information (e.g., to a videoconference server or other device), a predetermined or default amount of allocated time per slide can be allocated to the corresponding agenda item. For example, an allocated time of 30 seconds per slide can cause a determination of a suggested time period duration of 20 minutes for an agenda item for the slide presentation. In another example, if the scheduling user uploads a video as videoconference content information to be presented during the videoconference, and the video has a duration of 5 minutes, the corresponding suggested agenda item for this content can be determined as having a time period duration of 5 minutes (or slightly more than 5 minutes (e.g., 10-15 seconds) to allow time for the associated participant user to introduce the content during the videoconference). In another example, the scheduling user uploads minutes or a transcript of a previous meeting, which is automatically determined as a suggested agenda item named “Review minutes of previous meeting” and which is automatically assigned a time period duration of 3 minutes based on the length of those minutes (e.g., amount of text or pages).

Another factor that can be used to determine suggested agenda items can be participant users of the created videoconference. Some implementations can examine information provided by and/or about participant users, if user consent has been obtained from those participant users. For example, participant users having particular titles (e.g., job titles, organizers, etc.) can be allocated a particular position in the agenda item sequence and/or a particular amount (or percentage) of time duration for their associated agenda item. For example, a participant user having a company title or project title of “team lead” (e.g., determined from an accessible organization chart, project description, etc.) can be associated with a first (or early) agenda item and/or a greater time duration in their associated agenda item time periods than other participant users. Some implementations can examine prior videoconferences, similarly as described above, to determine if agenda items in the similar prior videoconferences used the names of participant users as agenda items, and these same names can be used as suggested agenda items in the created videoconference. Some implementations can substitute one or more of the prior participant user names with current participant user names that are different in the created videoconference and/or adjust the time periods accordingly. For example, if there are fewer participant users and agenda items in the created videoconference as compared to prior videoconferences, the time period durations can be expanded by an equal amount to fill the duration of the videoconference.

Another factor that can be used to determine parameters of suggested agenda items can be priorities or weights that are assigned to agenda items, where some agenda items may have different priorities (e.g., weights) than other agenda items. For example, a higher-priority agenda item can be provided with more importance (e.g., emphasis) than a lower-priority agenda item during the videoconference. This greater emphasis can include an earlier position in the sequence of agenda items in the agenda, a longer time duration, an immunity to being changed (e.g., reordered) or reduced in time period duration, having a more prominent notification associated with the agenda item, etc. Various priority levels or weights can be assigned particular values in a predetermined scale of values (e.g., 1-10, or other range of values), for example.

In some implementations, priorities (e.g., priority values) can be automatically assigned to particular suggested agenda items based on one or more factors. These factors can include whether the same agenda item was in one or more previously scheduled and/or conducted videoconferences, whether the same agenda item was skipped in a previous videoconference (e.g., giving that agenda item a higher priority since it was previously skipped, or in some implementations giving that agenda item a lower priority since it is considered not important), particular users associated with the agenda items (e.g., agenda items associated with users having a higher rank on an accessible stored organization chart can be assigned a higher priority than other users of lower rank on the chart), whether content information is associated with the agenda items, the type of content information associated with the agenda items (e.g., video, text, images, audio, etc.), the number of participant users, content items, child agenda items, and/or other items associated with particular agenda items, and/or other factors.

In one example, a particular agenda item is associated with videoconference content information such as a document. A number of participant users are associated with the document, e.g., as contributors to the document based on a stored history of edits to the document. This agenda item can be assigned a higher priority than a different agenda item that is also associated with a document, where that document has fewer participant users associated with it. In another example, an agenda item associated with a greater number of videoconference content items (e.g., number of documents, slides, pages, etc.) or a greater size/amount of content in a videoconference content item (e.g., based on length, number of pages or text characters, an audio or video duration, etc.) can be associated with a higher priority than other agenda items having a fewer number or amount of content. In another example, an agenda item associated with a content item having a greater amount of tracked changes and/or user comments can be assigned a higher priority than agenda items associated with content items with fewer of these elements. In another example, an agenda item associated with a label or content item having particular content determined to be more related to or important to the videoconference than other agenda items can be assigned a higher priority level. For example, particular keywords or key phrases found in the associated content item by the system (e.g., “important”) can indicate a higher priority for the associated agenda item.

In some implementations, a user may assign one or more priority levels, e.g., in block 218 described below, and suggested agenda item parameters (e.g., time periods) can be determined based on such user input.

Various parameters can be adjusted based on determined priority levels. In some examples, a higher-priority agenda item can be assigned a greater time period duration than an agenda item having a priority level lower than that agenda item. Particular priority levels can be associated with predetermined time period durations or predetermined percentages of total videoconference duration, e.g., as stored user preferences or stored default associations. In another example, the system can assign a higher-priority agenda item to a higher position in the sequence of agenda items than lower-priority agenda items, so that the higher-priority agenda item is presented earlier during the videoconference than the lower-priority agenda items. In some implementations, a higher-priority agenda item can have other attributes as described herein.

User data associated with participant users (and/or a scheduling user) can be used to determine suggested agenda items, if user consent has been obtained to access such user data. For example, user comments input from participant users (and stored in available storage) in prior videoconferences and/or in other contexts (e.g., social network service or other network service) can be used to determine suggested agenda items. User data can be retrieved and used which describes times and events obtained from a participant user's calendar stored in accessible storage. Documents, images, text, or other data associated with a participant user and/or a scheduling user can be analyzed by a system to determine suggested agenda items.

In some implementations, the system can similarly provide one or more suggested scheduling parameters for the created videoconference that are similar to one or more prior videoconferences (as described above for block 208), e.g., starting time, duration, participant users, etc., e.g., if such scheduling parameters have not yet been specified.

In block 218, agenda input is received which specifies one or more agenda items (or agenda item parameters) for the created videoconference. For example, the agenda input can be user input provided in the agenda creation interface, or can be data obtained from accessible storage or a different source. In some examples, the user input can include selections of the user from displayed menus, and/or input of text or other information by the user, e.g., into input fields or other areas of the user interface.

The agenda input can specify one or more parameters of one or more agenda items, and/or can change one or more parameters of one or more suggested agenda items that have been provided by the system. For example, one parameter of an agenda item can be an agenda item identifier (e.g., name or label) identifying the agenda item, e.g., a subject name, topic name, participant user name, or other identifier. Another parameter can be a position or rank of the agenda item in the agenda (e.g., a position in the order or sequence of agenda items to be sequentially performed during the videoconference, such as 1st, 4th, etc.). For example, agenda input can specify the identifier and/or order position via direct input (e.g., keyboard input, voice input, etc.), selection from a menu, etc.

Another parameter can be the time period duration for the agenda item indicating the length of time which the agenda item is to be active during the videoconference. In some examples, agenda items can be associated with specified times that inherently indicate the position of the agenda item within the agenda order. For example, an agenda item can be specified with a start time and an end time (e.g. “11:00 am to 12:00 pm”), and the position of the agenda item in the agenda item sequence can be determined by comparing its start/end times with the start/end times of the other agenda items in the agenda.

Another parameter can be a priority or priority level for an agenda item. Some implementations can receive agenda input that specifies priorities or priority levels for one or more of the agenda items. For example, the user may specify in the agenda input that one or more particular agenda items have a higher priority than other agenda items in the agenda, where the higher priority causes the agenda item to be assigned an earlier position in the agenda item sequence, may prevent reduction in time duration of that agenda item before other lower-priority agenda items are reduced (unless consented to by the scheduling user and/or associated participant user), and/or other effects. In some examples, the user can assign a priority level to an agenda as a value or as a qualitative indicator (e.g., “high,” “low,” etc.). In some implementations, a parameter that is a weight for an agenda item can be used instead of or in addition to a priority parameter, where higher-weighted agenda items are considered to have greater importance than lower-weighted agenda items.

Another parameter can specify one or more participant users associated with the agenda item, where the participant users have been designated to be a participant in the videoconference, e.g., by the scheduling input of block 208 or the suggestions of block 216. For example, an associated participant user can be designated to present the agenda item during the interface, start a discussion about the agenda item, etc. In some examples, a menu (e.g., drop down menu, list, etc.) can be presented in the agenda creation interface listing the participant users, from which the scheduling user can select one or more users to associate with a particular agenda item.

Some implementations can provide agenda items at different hierarchical levels, where that an agenda item at a first (e.g., top) hierarchical level may be considered to have one or more (child) sub-items grouped within it at a second hierarchical level, one or more sub-items may have (child) third-level sub-items grouped within them, and so on. In some implementations, the hierarchical level, parent agenda item, and/or child agenda items of an agenda item can be specified as parameters of that agenda item.

In some implementations, in response to receiving agenda input from the user and/or other source (e.g., specifying one or more user-specified agenda items or agenda item parameters), one or more suggested agenda item parameters and/or additional suggested agenda items for the agenda can be determined based on the received agenda input. The suggested agenda items and parameters can be determined based on one or more factors similarly to the suggested agenda items described above for block 216. In some implementations, if some parameters of an agenda item have been specified by the agenda input, one or more other parameters of that agenda item can be determined automatically.

For example, stored default or reference parameters can be used to determine suggested parameters for agenda items. In one example, if the identifier of an agenda item has been specified by agenda input, that identifier can be parsed and recognized or identified by the system and matched to a reference identifier in a list of reference identifiers to select a default time period duration (and/or other parameters) associated with the reference identifier which is assigned as a suggested duration for the agenda item. In another example, if agenda input specifies an identifier of a first agenda item to be “Introduction,” then a suggested identifier for the last agenda item in the agenda can automatically be determined as “Conclusion” based on a stored template, look-up table, or list of suggested related agenda items. In another example, if the agenda input specifies a particular participant user to be associated with a particular agenda item, then a predetermined time period duration associated with that participant user can be automatically assigned to the agenda item, e.g., as a suggestion. In another example, particular participant users can be automatically assigned to particular agenda items based on the agenda item identifiers, e.g., based on any of the factors as described above. In one example, in a play or movie script having characters, the system can automatically assign a participant user to particular agenda items associated with dialogue spoken by a character assigned to that participant user.

In block 220, an agenda is determined that is associated with the videoconference record generated in block 210. The agenda includes a sequence of the agenda items determined from the agenda input of block 218 and from suggested agenda item parameters of blocks 216 or 218 that the scheduling user has not changed or deleted. For example, the system can store the agenda item parameters in the videoconference record, or can store the agenda item parameters in a different record or other storage in association with the videoconference record. Some implementations can display a graphical representation of the agenda in the agenda creation interface. For example, a graphical timeline representing the duration of the videoconference can include markers, labels, or other indicators indicating the start times of the agenda items of the videoconference. Such a graphical representation can be displayed at various stages of the agenda creation process, e.g., in any or all of blocks 208-218.

Some implementations can display (or otherwise output) an alert, warning, or similar indication in the agenda interface, e.g., when storing the agenda item parameters. For example, if the system determines or estimates that the agenda items have time period durations longer than the videoconference time duration, a warning can be displayed. In some examples, if one or more agenda items are correlated to videoconference content information such as slides, documents, etc., then the system can analyze the videoconference information (or receive such an analysis from a different system or system component) and estimate an amount of time that these agenda items may take to discuss or present, and can compare such estimated amounts of time with the specified durations of corresponding agenda items. As a result of the comparison, a warning can be displayed to the user that the estimated amount of time for the content is different than the duration of the corresponding agenda item, e.g., if the difference is a threshold amount of time or more. In some examples, if the sum of the estimated amounts of time for the specified agenda items does not fit within the duration of the videoconference, a warning can be displayed.

In block 222, in some implementations, a notification can be sent to one or more participating users who are designated to participate in the scheduled videoconference. For example, the notification can be sent to each participating user or to a subset of participating users, e.g., to one more devices associated with the participating users over a communication network. The content of the notification is output to the receiving participant users by a device used by the participant user. In some examples, the notification can be sent after the participants of the videoconference are determined and, e.g., before the videoconference commences. In some implementations, multiple notifications can be sent, e.g., another notification can be sent at a predetermined time period (e.g., short time period such as 5 or 10 minutes) before the videoconference commences, and/or during the videoconference if the participating user has not yet joined the videoconference.

The notification can include or indicate the parameters of the videoconference, e.g., start time, duration, participant users, organizing user, etc. In some implementations, the notification can include all or a portion of the agenda for the videoconference, and in some implementations can provide different portions of the agenda to different participant users. For example, in some implementations, participant users who are associated with (e.g., responsible for presenting) one or more agenda items can be sent agenda item information in the notification. In some implementations, the notification provides the agenda items associated with the respective recipient participant user (e.g., the start times and duration of these agenda items). Some implementations can provide all of the agenda items in the notification and can highlight the agenda items with which the receiving participant user is associated. In some implementations, the displayed notification can include a displayed link or other selectable control allowing the receiving participant user to access the videoconference data stored in the videoconference record, e.g., to change one or more parameters of the videoconference and/or the agenda.

In block 224, it is checked whether user input is received by the system which indicates to adjust one or more of the agenda items of the stored videoconference scheduled in blocks 208-220 (and/or adjust any other parameters of the scheduled videoconference or videoconference record). For example, a user may have input a command to display an agenda interface that allows changes to the stored agenda. The user may provide input to the agenda interface to change an identifier, position, time duration, or other parameter of one or more agenda items of the scheduled videoconference record before the videoconference commences. The adjusting user can be the scheduling user and/or one or more participant users of the scheduled videoconference. Some implementations can allow particular participant users to be enabled to change, or restricted from changing, all or some of the videoconference parameters and/or agenda items (e.g., particular agenda items designated by the scheduling user).

In some implementations, the user input can include messages or responses received from one or more participant users that can be considered an indication to adjust one or more agenda items of the stored agenda. For example, if a notification was sent to a participant user in block 222, the participant user may respond to the notification with a message or response indicating that the user cannot participate in the videoconference. This can cause the system to adjust the agenda items based on this response. For example, agenda items assigned to the user who cannot participate can be associated to a different participant user, can be removed from the agenda, and/or can be assigned a different time period duration. In one example, an agenda item associated with a participant user who cannot participate can be associated to a participant user supervisor of that user, or to the organizer user of the videoconference. In another example, a message or response from a participant user may indicate that the participant user is restricted in participating in the videoconference, e.g., to certain times, and therefore the agenda items are adjusted. For example, if a participant user provides a message indicating that the user is able to participate just in the first half of the videoconference, then any agenda items associated with that user can be moved in the agenda item order to the first half of the videoconference.

If user input adjusts one or more of the agenda items, the method continues to block 226, in which the agenda is updated based on the user input. For example, user input may indicate to change one or more agenda item parameters including agenda item identifiers, the order of one or more agenda items, time period durations, the starting times of one or more agenda items, the priorities, and/or participant user(s) associated with agenda items, and these parameters are adjusted as indicated by the user input. In some examples, the user can select an endpoint to a graphical representation of the time duration presented in an agenda interface and can drag (e.g., with a finger or pointing device) the endpoint to adjust the start or end time associated with that endpoint. A user may also input new start or end times, identifiers, durations, or other parameters of agenda items in displayed fields of the agenda interface.

In block 228, one or more other agenda items are automatically adjusted which were affected by the adjustments applied in block 226. For example, if an agenda item has been associated to a different user or the order of agenda items has been changed, the system can check if there are conflicts with user participation availability in the changed agenda, and may adjust agenda item order, time period durations, and/or associated users further based on known user availability. In another example, if the user changed the duration of an agenda item, then the other agenda items of the videoconference can be adjusted in duration to accommodate that change in duration so that the agenda item time period durations fit the videoconference duration. In one example, if the user input reduced the duration of one or more agenda items, then one or more other agenda items can be increased in duration to fill the total duration of the videoconference. Similarly, if the user input increased the duration of one or more agenda items, then one or more other agenda items can be decreased in duration so that the total duration of the videoconference does not overlap the allocated duration of the videoconference.

In some examples, all the other agenda items that were not adjusted by the user can be automatically adjusted in duration by amounts (e.g., equal amounts) to fit within the total duration of the videoconference. Thus, agenda item durations not specified or adjusted by user input are automatically adjusted to fit within the videoconference duration. For example, if an agenda has six agenda items that are each 10 minutes in duration, and the user input increases the duration of one of these agenda items to 15 minutes, then the other five agenda items not adjusted by user input can each be automatically reduced in duration by 1 minute. In some implementations, the time period durations of the remaining agenda items that were not adjusted by the user input can be adjusted to fit within the time duration of the videoconference in a manner proportional to the size of their durations with respect to each other (or proportional to their original percentage of the videoconference duration). For example, if an agenda has three agenda items, agenda item A of 10 minutes, agenda item B of 20 minutes, and agenda item C of 30 minutes, and the user input reduces agenda item C to 18 minutes, then the 12 minutes that are now freed by this reduction can be assigned as 4 minutes to agenda item A and 8 minutes to agenda item B based on the size of their original durations with respect to each other.

In some implementations, if the user input adjusts all but one of the agenda items, and then if the last user-unadjusted agenda item is adjusted by user input, some or all of the other agenda items are automatically adjusted even though they have been previously specified by user input (e.g., the other agenda items can be adjusted to fit within the time duration proportional to their durations). This feature may prevent a locked situation in which the user input has adjusted all of the agenda items, allowing none of the agenda items to be adjusted automatically to fit within the videoconference duration.

In some implementations, particular ones of the other agenda items can be adjusted, or some of the other agenda items can be adjusted more than other agenda items that were not adjusted by the user input. For example, one or more particular agenda items can be adjusted in time period duration as determined based on one or more factors such as assigned priorities to the agenda items. In some examples, if the other agenda items (e.g., the agenda items not adjusted by the user) have an associated priority, then the highest priority of these agenda item(s) can be increased in time period duration (or can be agenda items not reduced in duration). In some additional examples, the highest priority agenda items can be increased in duration by a greater amount than lower priority agenda items (e.g., in proportion to their priority levels), or can be reduced in duration by a lower amount than lower priority agenda items (e.g., in proportion to their priority levels). In other examples, an agenda item that is associated with a particular user title or other parameter, e.g., a leader or organizer user of the videoconference, can be the only agenda item increased in duration, or can be increased in duration by a greater amount (or decreased in duration a lower amount) than the other agenda items not adjusted by the user.

Some implementations can display (or otherwise output) a warning or similar indication in the agenda interface if the system determines that one or more adjusted agenda items have time period durations that provide a total videoconference duration longer than the scheduled videoconference duration, similarly as described above.

In some implementations, one or more suggested agenda item parameters can be determined based on the adjustment to agenda items, similarly to the suggested agenda items described above. For example, if the user changes an agenda item identifier to a new identifier, then a new time period duration for that agenda item can be suggested by the system based on one or more factors described above (e.g., prior videoconferences, default duration for that new identifier, etc.).

In block 230, the adjustments determined in blocks 226 and 228 are stored in the videoconference record, e.g., in response to user input in the agenda interface that indicates the user wants to accept the adjustments provided in blocks 226 and 228. The method can then return to block 222 in some implementations, to notify one or more user participants in the videoconference of the adjustments to the agenda. Some implementations can return to block 224 to check for additional adjustments without sending notifications.

If, in block 224, user input does not adjust one or more of the agenda items, the method can continue at block 224 to check for adjustments (and check for other events, e.g., the start of the videoconference).

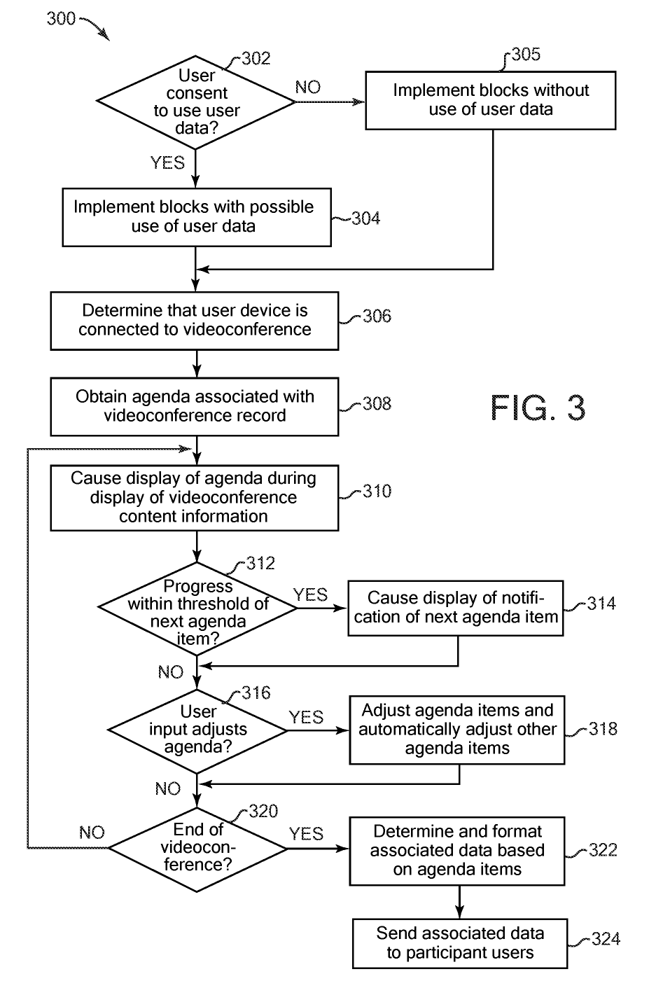

FIG. 3 is a flow diagram illustrating one example of a method 300 to provide an agenda during a videoconference. In some implementations, method 300 can be implemented, for example, on a server system 102 as shown in FIG. 1. In other implementations, some or all of the method 300 can be implemented on a system such as one or more client devices 120, 122, 124, or 126 as shown in FIG. 1, and/or on both a server system and a client system. In described examples, the implementing system includes one or more processors or processing circuitry, and one or more storage devices such as a database 106 or other storage. In some implementations, different components of one or more servers and/or clients can perform different blocks or other parts of the method 300.

In some implementations, method 300 can be performed after a videoconference has been scheduled, including agenda items, as described above with reference to FIG. 2. For example, the current time may match the start time of the videoconference, and the videoconference is initiated and connected to by participant users via their devices. In one example, a videoconference session is started by a server device or a client device, and the participating devices connect to the session over a network.

In block 302, it is checked whether user consent (e.g., user permission) has been obtained to use user data in the implementation of method 300. For example, user data can include user preferences, user biometric information, user characteristics (identity, name, age, gender, profession, etc.), information about a user's social network and contacts, social and other types of actions and activities, content, ratings, and opinions created or submitted by a user, a user's current location, historical user data, etc. One or more blocks of the methods described herein may use such user data in some implementations. If user consent has been obtained from the relevant users for which user data may be used in the method 300, then in block 304, it is determined that the blocks of the methods herein can be implemented with possible use of user data as described for those blocks, and the method continues to block 306. If user consent has not been obtained, it is determined in block 305 that blocks are to be implemented without use of user data, and the method continues to block 306. In some implementations, if user consent has not been obtained, the remainder of method 300 is not performed.

In block 306, it is determined that a user device is connected to a videoconference. For example, the user device may have connected over a network to a videoconference session provided by a server device or other device. The current time may be the starting time of the scheduled videoconference that is stored in a record in storage accessible to the user device. For example, the user device can compare the current time to the scheduled videoconference time and output a notification on the user device that the videoconference has started, and/or can automatically attempt to connect to the videoconference at the scheduled starting time.

In block 308, an agenda associated with the videoconference record of the connected videoconference is obtained. For example, agenda item parameters stored in or in association with the videoconference record can be retrieved. The parameters can include information as described with reference to FIG. 2.

In block 310, the agenda (or portion thereof) is displayed in addition to display of videoconference content information during the videoconference. Videoconference content information can include live captured information, e.g., a stream or feed of images (such as still images or video) depicting one or more of the participant users that are captured by cameras during the videoconference to provide a current depiction of those users. Videoconference content information can also or alternatively include presentation content information, e.g., slides, documents, images, video, audio, and/or other types of data that are presented during the videoconference. For example, during display of one or more of the participant users during the videoconference, the agenda (or a portion thereof) can be displayed. In some implementations, the agenda can be displayed in the same display interface as the videoconference content information, e.g., superimposed on, above, below or to the side of videoconference content information. Some implementations can display the agenda in a different interface, window, portion of the display, or a different display during the videoconference.

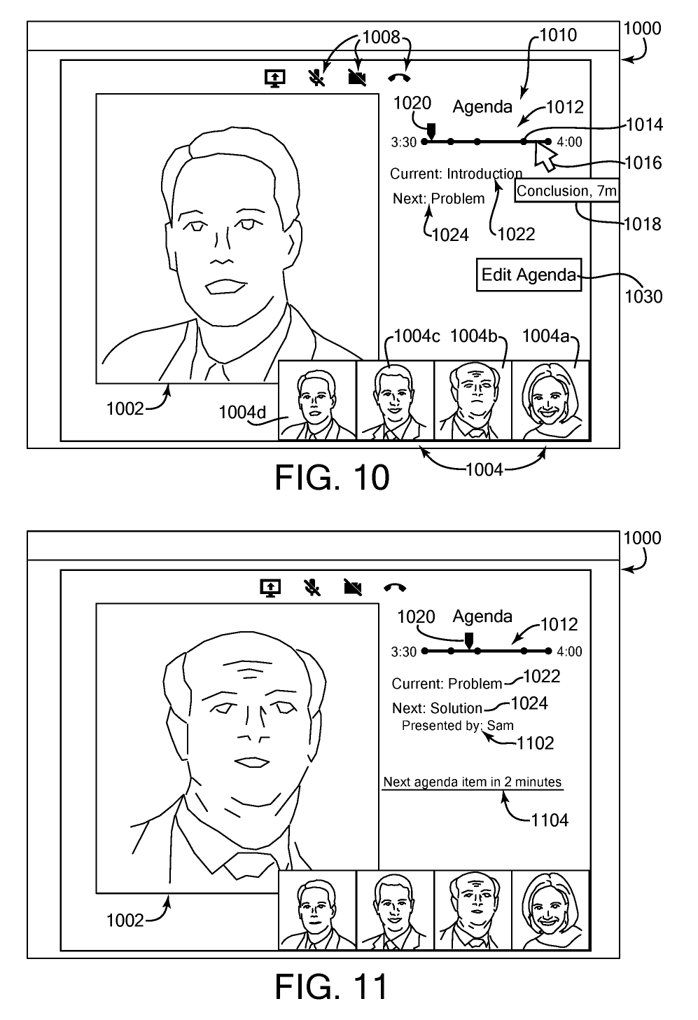

In some implementations, a portion of the agenda is displayed. For example, the agenda item that is currently active (e.g., the agenda item having a time period at the current time) can be displayed, while the other agenda items of the agenda can be omitted from display. In some examples, an identifier (e.g., label, icon, etc.) of the active agenda item and/or other parameters of the active agenda item can be displayed. In some implementations, the currently active agenda item and the upcoming (next) agenda item in the agenda item sequence can be displayed. Some implementations can display the names or other identifiers (e.g., pictures) of the participant user(s) that are associated with the currently active agenda item, e.g., displayed near the active agenda item. Similarly, some implementations can display an identifier of the participant user(s) that have been associated with the next agenda item, e.g., near the next agenda item in the videoconference display interface. Some examples of displaying a portion of an agenda are described below with reference to FIGS. 10-11.

Some implementations can include a display of a timeline or other graphical representation of the agenda in the videoconference interface (or in a separate interface or screen area). For example, a horizontal or vertical line can be displayed, with each agenda item of the agenda marked on the timeline with a displayed marker. In some examples, the starting times of the agenda items can be marked on the timeline. In some implementations, information relating to an agenda item and/or videoconference parameters (e.g., identifier, duration, etc.) can be displayed if a user-controlled displayed pointer is moved over the agenda item marker or the agenda item marker is otherwise selected by a participant user. A progress indicator can also be displayed in association with the timeline, which indicates the current point of progress of the videoconference relative to the agenda items of the agenda. For example, a progress indicator can be displayed at a point on the timeline to indicate the current, active agenda item of the videoconference.

In some implementations, the agenda (or portion of the agenda) is displayed in all of the displayed interfaces of participant devices of the videoconference. Some implementations can cause the agenda or portion of the agenda to be displayed only by some of the participant devices of the videoconference. For example, agenda items associated with particular participant users may be displayed by the devices of those participant users.

In block 312, it is checked whether the current point of progress of the videoconference is within a threshold amount of time of the next agenda item of the agenda. In some examples, the threshold amount of time can be a default amount of time, can be specified by the scheduling user that created the videoconference, or can be determined automatically by the system based on the time duration of the videoconference and/or the time period duration of the current agenda item. In some examples, the threshold amount of time can be 0 seconds (e.g., no threshold), 30 seconds, 1 minute, 2 minutes, 5 minutes, etc. If the current point of progress is not within the threshold amount of time, the method continues to block 316, detailed below.

If the current point of progress is within the threshold amount of time, the method continues to block 314, in which a display of an agenda notification is made (or other type of output, e.g., audio, haptic, etc.). In various implementations, the agenda notification can indicate the expiration of the current agenda item and/or can indicate the next approaching agenda item that will occur in the agenda (within the threshold period of time). In one example, the current agenda item is “Introduction” and the current point of progress of the videoconference has reached a point 2 minutes before the next agenda item “Problem” will become the current agenda item of the videoconference. An agenda notification stating “Next topic: Problem, in 2 minutes” is displayed in the videoconference interface. In various implementations, the agenda notification can be displayed prominently, e.g., in a large size over a main videoconference display, or can be displayed more subtly, e.g., to the side of the main display and in a smaller size so as to not distract the participant users from the videoconference content information. In some implementations, the notification is displayed by all of the participant devices of the videoconference. In other implementations, the notification is displayed only by some of the participant devices. For example, a notification can be displayed by the participant device of the participant user who is associated with the next agenda item, e.g., as a presenter of information during the next agenda item.

Some implementations can check whether the current point of progress is within a threshold amount of time of other events and output notifications for those events. For example, it can be checked whether the current point of progress is within a threshold time of the end of the videoconference, or of a particular time, agenda item, or event added to the timeline by a participant user. In some implementations, an output notification can indicate a determined rate of progress through an agenda item or associated videoconference information and/or can include an estimate of an amount of time sufficient to complete presentation of the agenda item or content information at the determined rate of progress, examples of which are described below.

After block 314, or if the current point of progress is not within the threshold amount of time in block 312, the method continues to block 316, in which it is checked whether user input is adjusting the agenda, which includes adjusting progress of the videoconference through the agenda. For example, a participant user can adjust the agenda during the videoconference, and the adjustments can be updated at each display of each participant device of the videoconference. The agenda can be adjusted in a variety of ways, which can include changing a current point of progress of the videoconference, e.g., from one active agenda item to a new active agenda item (e.g., received user input can select a control to skip forward or backward to a different agenda item in the agenda item sequence, move a current progress indicator on a displayed timeline or other displayed schedule to a new agenda item, stop or pause the advancement of the active agenda item to a next agenda item, etc.). Furthermore, the agenda can be adjusted by changing one or more parameters of one or more agenda items of the agenda, e.g., changing one or more time period durations of agenda items, changing a participant user who is associated with an agenda item, changing a priority of an agenda item, and/or changing any other parameters of agenda items. Some examples of agenda adjustment are described below with respect to FIGS. 10 and 11.

In some implementations, one or more participant users can add events to the agenda which are different than agenda items (e.g., can have a different appearance and/or notification during the videoconference). For example, an event can be created by selecting a particular point on a displayed timeline and entering associated text, where the text will be displayed in a notification when the current point of progress of the videoconference reaches that point. The notification can be displayed only to that user, to selected participating users, to all participating users, or other subsets of users in various implementations.

If user input is adjusting the agenda, the method continues to block 318, in which the agenda items are adjusted in accordance with the user input. The agenda item adjustment can include updating a status indicating which current agenda item is active, and/or automatically adjusting agenda item parameters to accommodate the user-specified changes. Adjusting parameters may include, for example, associating agenda items with different participating users, moving unvisited agenda items to a position in the agenda order to allow them to still become active in the videoconference, maintaining a total agenda item duration within the designated videoconference duration, etc. For example, agenda item time period durations can be adjusted such that the agenda remains within the scheduled video conference duration, e.g., unless the user input has adjusted the total duration of the videoconference. For example, if the user input has adjusted a duration of one or more agenda items, these new durations are stored and the other agenda items of the agenda that were not adjusted by the user input are automatically adjusted to fit within the duration of the videoconference. In some implementations, the automatic adjustments can be similar in one or more features to the automatic adjustment described above for the agenda creation interface of FIG. 2. The adjusted agenda is stored in the videoconference record and the display of the agenda in the videoconference display interface is updated in accordance with the adjustments (e.g., for all participant devices).

After block 318, or if the user input does not adjust the agenda in block 316, the method continues to block 320, in which it is checked whether the videoconference has ended. For example, the videoconference can end based on user input received at a participant device from a participant user to command the videoconference to end. In some implementations, particular participant users are enabled to command the videoconference to end, e.g., the scheduling user or other organizing user of the videoconference, a designated leader user, etc. In some implementations, the videoconference ends after all participant devices have disconnected from the videoconference session.

If the videoconference has not ended, the method can return to block 310 to continue displaying the agenda during the videoconference. If the videoconference has ended, then in block 322, associated data related to the videoconference can be determined and formatted based on the agenda items of the agenda. For example, the associated data can include data describing notes that were input by one or more participant users during the videoconference, e.g., descriptions of topics discussed, summaries of content presented, reminders of later tasks related to videoconference content information, etc. The note data may have included text, selection of images, drawings or sketches (e.g., drawn by a user's finger or a stylus), input by an input device (e.g., touch screen, pointing device, voice command recognizer, etc.). This received note data can be stored in association with stored indications of the agenda items that were active at the time the note data was received.

At the end of the videoconference, one or more collections of note data that were input by one or more participant users can be determined. For example, all of the notes input by a particular participant user can be grouped into a collection for that user. In another example, all of the note data input by all of the participant users can be grouped into a collection of all note data received, e.g., intended for all participant users or a subset of participant users. Some implementations can include a transcript of speech input during the videoconference with the note data.

In some implementations, the note data can be organized within the collection(s) based on the agenda items that were active in the videoconference at the time the notes were input by the participant users. For example, the notes can be collected into a text format in which text headings are provided, where each text heading is one of the agenda item identifiers and the note data following a heading is the note data received while the corresponding agenda item was active in the videoconference. Some implementations can designate graphically the agenda items active for particular note data, e.g., with borders, boxes, arrows, or other indications.

In another example, the associated data that is determined and formatted in block 322 can include a recording of the videoconference, or a recording of one or more portions of the videoconference. For example, the recording can include video data having multiple image frames that were transmitted to participants during the videoconference and including audio data encoding the audio that was exchanged during the videoconference. For example, the formatting based on agenda items can include insertion of chapter headings, “bookmarks,” or other placeholder markers in the recording data that correspond to the starts of agenda items. A marker can be displayed and selected by a user to cause playback (e.g., output by output device) of a particular portion of the recording data corresponding to the agenda item associated with the selected marker. In additional examples, the titles or other parameters of particular agenda items can be displayed or output during playback of the portions of the videoconference corresponding to those agenda items. In some implementations, portions of the recording are prepared for a receiving participant user based on association with that participant (e.g., presentations made by the particular user), based on association with particular participants (e.g., presentations made by users indicated to be of interest to the receiving user based on settings, preferences, organization charts, etc.), and/or based on input from the receiving user during the videoconference (e.g., selection of a control in a user interface during the videoconference). In some implementations, audio recording data that records the audio of the videoconference, without video data, can be determined and formatted as associated data.

In block 324, the associated data formatted in block 322 is sent to appropriate participant users, e.g., over a network to the participant devices or to other devices used by participant users. For example, the associated data can be sent to addresses of participant users, e.g., email address, user account, etc. In some examples, as described above, an individual set of associated data can be sent to each participant user providing at least a portion of the associated data, e.g., note data that was input by that user (and including transcribed data of speech made by that user in some implementations), video and/or audio recording data of interest to that user, etc. In some implementations, a collection of all determined associated data received (or a subset of the associated data) can be sent to all participant users or a designated subset of participant users.

The blocks and operations described in the methods disclosed herein can be performed in a different order than shown or described, and/or performed simultaneously (partially or completely) with other blocks, where appropriate. Some blocks can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices 120, 122, 124, or 126 as shown in FIG. 1. In some implementations, one or more methods described herein can be implemented, for example, on a server system 102 as shown in FIG. 1, and/or on both a server system and a client system. In some implementations, different components of one or more servers and/or clients can perform different blocks, operations, or other parts of the methods.

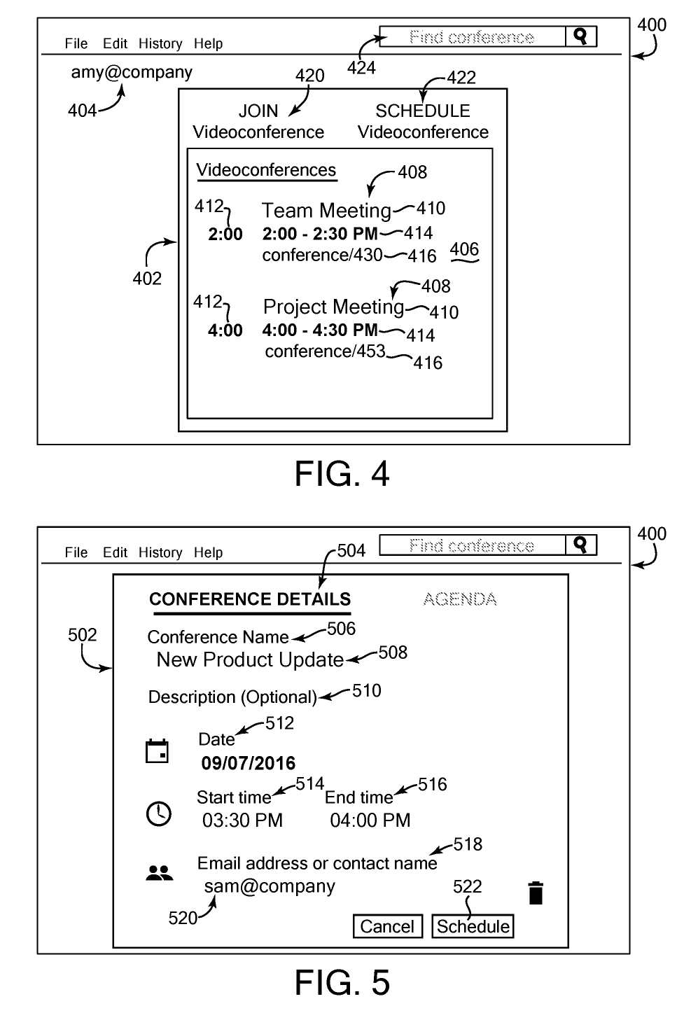

FIGS. 4-9 are diagrammatic illustrations of example user interfaces including one or more features for determining an agenda for a conference as described herein. Similarly labeled items across FIGS. 4-9 indicate similar parts and may not be described for each Figure.

FIG. 4 shows an example user interface 400 displayed by a display device of a system, e.g., one or more display screens, display projector, etc. In this example, user interface 400 includes menu options, e.g., from an operating system or application program, and displays a videoconference schedule interface 402 within the user interface 400. In other cases or implementations, the schedule interface 402 can fill the entire display area of the display device, such as a display screen or projector display area. In this example, a scheduling user who can provide commands to the scheduling interface 402 is indicated by network address 404, which can be an address or other identifier.

Videoconference schedule interface 402 can include a videoconference list 406 in which scheduled videoconferences 408 are displayed. For example, each scheduled videoconference 408 can include a videoconference identifier 410 that can be a label or title of the scheduled videoconference. A start time 412 indicates the start time of the videoconference (a calendar date can also be displayed, not shown). A videoconference duration 414 indicates the duration of the videoconference, here indicated by a start time and an end time. Other implementations can list a duration, e.g., in minutes or other time unit. This example also displays a link 416 that can be selected by a user (or can be sent to other users for selection) to join the associated videoconference. For example, if the current time is at or past the start time 412 of the videoconference, selection of the link 416 causes a videoconference display interface to be displayed and indicates the participating users that are connected to the videoconference. Other implementations can display a graphical button or other control for link 416. Some examples of a videoconference display interface are described below with reference to FIGS. 10 and 11.

Additional information and/or controls can also be displayed for the schedule interface 402. For example, a join control 420 can be selected by a user to join a particular videoconference, e.g., a videoconference 408 of list 406 which was previously selected by the user. In some implementations, after selecting join control 420, an input field can be displayed in which the user can input the identifier of a videoconference to join.

A schedule control 422 can be displayed for the schedule interface 402. Schedule control 422, when selected, can cause a scheduling interface to be displayed that allows the user to create and schedule a new videoconference to add to list 406. Some examples of a videoconference scheduling interface are described below.

Some implementations can provide a search field 424 to allow the user to search for a videoconference that has been scheduled. For example, the interface user can search for videoconferences created by the scheduling user and/or created by other users and accessible to the interface user, e.g., over a network connected to the system displaying the interface 400. Videoconferences can be searched for based on identifier (e.g., name), date, or other search criteria.

FIG. 5 shows an example videoconference creation interface 502 that can be displayed in response to the selection of the schedule control 422 shown in FIG. 4, or can be displayed in response to other user commands (e.g., voice commands, etc.). In this example, videoconference creation interface 502 is displayed in the user interface 400.

Videoconference creation interface 502 includes a details selector 504 that, when selected as shown in FIG. 5, causes the interface 502 to display information and controls allowing a user to input various parameters for a scheduled videoconference. These parameters can include a videoconference identifier 506 (e.g., name). In this example, the scheduling user has input a name of “New Product Update” for the scheduled videoconference. The parameters can also include a description 510 which can be related to the videoconference (e.g., goals of the videoconference, main subjects to be covered during the videoconference, etc.). The parameters can also include a date 512 that designates the day, month, and/or year on which the videoconference is to take place. The parameters can also include a start time 514 and end time 516 of the videoconference, which establish the duration of the videoconference. In this example, the user has input a start time of 3:30 PM and an end time of 4:00 PM, thus setting a videoconference duration of 30 minutes. The parameters can also include participant users 518, who are users that are invited to and can participate in the videoconference (the scheduling user can automatically be assigned as a participant user by default, in some implementations). In this example, the scheduling user has selected or input a user address 520 of a participant user, and can input additional participant user identifiers (e.g., addresses and/or names).

If the user has finished inputting parameters, the user can select the schedule control 522 to save the scheduling parameters in an associated videoconference record.

FIG. 6 shows an example agenda creation interface 602 that can be displayed in response to the selection of the agenda selector 604 (e.g., the agenda selector 604 can be selected from schedule interface 502 in some implementations). In this example, agenda creation interface 602 is displayed in user interface 400.

Agenda creation interface 602 includes agenda items 606 which can be suggested by the system and/or can be input by the scheduling user. Each agenda item is displayed with an agenda identifier (e.g., name) 608 and a duration 610. Some implementations can display the duration 610 as times, e.g., similar to start time 514 and end time 516 of FIG. 5. Each agenda item can also be displayed with one or more associated participant users 612. In this example, the associated participant users 612 are not specified, and are displayed as user selection controls that allow the scheduling user to specify one or more participant users to be associated with the associated agenda item.

In the example of FIG. 6, some parameters of the agenda items 606 have been suggested by the system. For example, the suggested parameters of the agenda items 606 may in some implementations be determined based on one or more previous videoconferences, e.g., videoconferences scheduled at the same or similar time periodically in the past, such as the same day of the week for multiple previous weeks (e.g., a threshold number or more previous consecutive weeks), and at the same time of day. For example, the four agenda items 606 may be provided with the same agenda identifiers and same time period duration as the same four agenda items in the previous videoconference agendas.

In some implementations, one or more of the suggested agenda items 606 may be automatically determined based on videoconference content information that is intended to be transmitted from one or more participant devices to one or more other participant devices during the scheduled videoconference (after the scheduled videoconference has commenced). For example, a data selection control 614 can be selected by the user to allow selection of one or more data files or other content information to be input to the system for evaluation for suggested agenda items. In some implementations, the selected information can be designated for transmission to participant users during the videoconference. In some examples, the scheduling user can use data selection control 614 to select file(s) including slides or documents that include content information to be presented during the videoconference. The system can examine the selected files, e.g., using text analysis and text recognition techniques, to determine, for example, headings to various sections of the slides or documents. For example, the agenda item identifiers 608 of agenda items 606 can be retrieved from headings in a document outline selected by the scheduling user using control 614. In some examples, the durations 610 of the agenda items 606 can be determined based on previous agenda durations, can be determined based on a predetermined or default method, or can be determined based on the provided videoconference content information as described herein. In this example, the durations 610 can be determined to be equal for all agenda items 606, as shown in FIG. 6.

An add option 616, when selected by the user, allows additional agenda items to be added to the agenda. For example, the user can input an identifier for a new agenda item, a time period duration, and one or more associated participant users. Other agenda item parameters can also be displayed and edited by the scheduling user in some implementations. For example, a priority can be designated for each of one or more of the agenda items.

Agenda creation interface 602 can also display an agenda timeline 620. In this example, the agenda timeline 620 is graphical, e.g., a horizontal line (which alternatively can be a vertical line or other graphical diagram). Other implementations can display an agenda timeline as a list or sequence of times, e.g., in text format. The agenda timeline 620 can indicate the start time 622 and end time 624 of the videoconference, e.g., as times displayed at the start and end of the agenda timeline 620. The agenda timeline 620 can display markers 626 to indicate specific items or times for the agenda. For example, each display marker 626 can indicate the start of an agenda item. Thus, the markers 626 are spaced evenly apart due to the durations 610 of the agenda items being equal.

In some implementations, the scheduling user can cause additional information to be displayed based on interactions or selections of agenda timeline 620. For example, as shown in FIG. 6, a user-controlled pointer 630 can be positioned over, or pointing to, the agenda timeline 620 at a particular point (e.g., a “hover” selection). In response, information relating to the agenda, and/or to the selected point on the agenda timeline, can be displayed. For example, agenda information 632 can be displayed in response to the user moving the pointer 630 to select the agenda timeline. In this example, the pointer 630 points to the second agenda item on the agenda timeline 620, and the identifier and duration of this second agenda item are displayed in the agenda information 632. Additional or alternate agenda and videoconference parameters and other information can be displayed (or otherwise output by the user device) in various implementations. In some examples, the agenda information 632 can be removed from the display if the pointer 630 is moved away from the agenda timeline 620.

FIG. 7 shows an example of the agenda creation interface 602 of FIG. 6 after the user has modified an agenda item. The scheduling user can edit the parameters of agenda items in the agenda creation interface 602. For example, the scheduling user can select a parameter of an agenda item 606, e.g., an identifier 608 or duration 610, and input new parameter data to replace or change the parameter of the selected agenda item. In one example, the user can select an agenda item identifier 608 and input new text as a new identifier. In the example of FIG. 7, the user has selected agenda item identifier 704 and changed it from the suggested agenda item identifier of “Conclusion” to the identifier “Results.” In addition, the user has selected one of the participant users of the videoconference to be associated with the third agenda item as indicated by the user name displayed in user selection control 706. For example, the user selection control 706 can be selected by user input and a list of the participant users (not shown) of the videoconference can be displayed for selection.

Some implementations can allow the scheduling user to edit the agenda items in various other ways. For example, the user can rearrange the sequence of the agenda items, e.g., by selecting and dragging agenda item identifiers to different places in the displayed order, by changing an order value (not shown), etc.

In some implementations, the scheduling user can adjust the time period duration of one or more agenda items by adjusting portions of the agenda timeline 620. For example, the user can select a marker 626 of the agenda timeline 620 and drag or otherwise move the marker 626 to a new position on the timeline. The time period durations of the affected agenda items (e.g., the agenda items on both sides of a moved marker 626) are automatically adjusted based on the new position of the moved marker 626.

In the example of FIG. 7, the user has selected a marker 702 on the agenda timeline 620 which represents the start time of the third agenda item named “Solution” and has moved this marker to the left. This causes the time period of the Solution agenda item to be increased in duration by 3 minutes, resulting in a duration of 10 minutes. In addition, this has caused the time period of the previous agenda item named “Problem” to be reduced in duration by the 3 minutes, resulting in a duration of 4 minutes. The other agenda items are not affected by the movement of the marker 626.

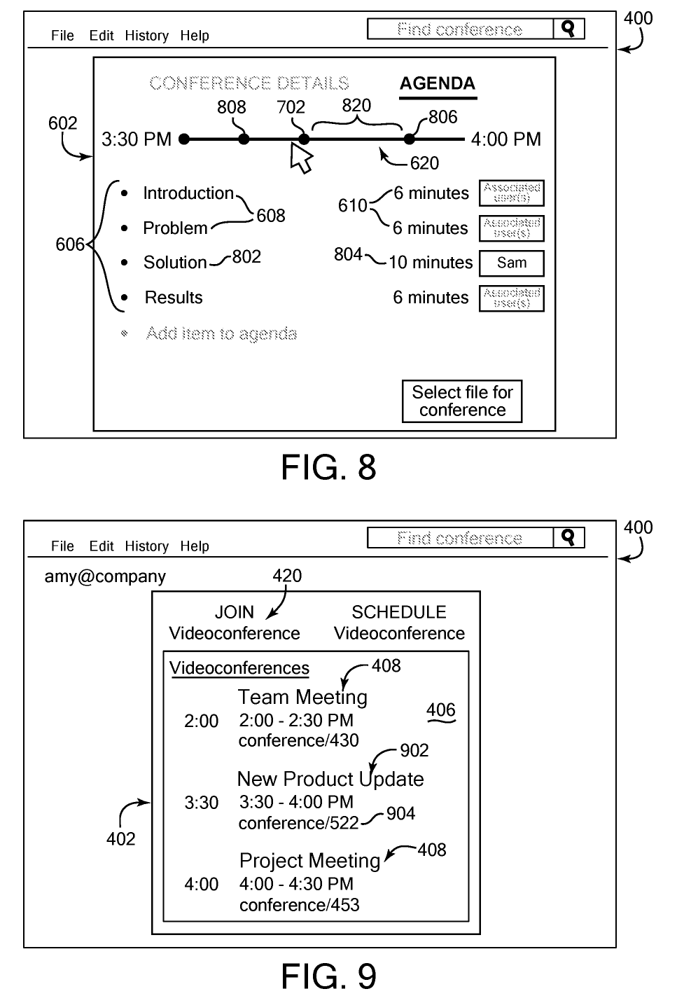

FIG. 8 shows the agenda creation interface 602 of FIG. 6 after the user has modified an agenda item, and further including an example of automatic adjustment of the other agenda items not specified by the user. In some implementations, after the user adjusts a duration of an agenda item time period in the agenda creation interface, the durations of the other agenda item time periods not set or adjusted by the user are automatically adjusted to fit within the designated duration of the videoconference, e.g., based on predetermined rules. For example, the other agenda items can be adjusted to have an equal time period duration among all the other agenda items that do not have durations specified by user input received in the agenda creation interface 602.

In the example of FIG. 8, the user has changed the duration 804 of the third agenda item 802 from 7 minutes (which may have been automatically determined as described for FIG. 6) to 10 minutes as shown. In some implementations, the user may have directly edited the duration 804 of agenda item 802, e.g., by selecting the duration 804 and inputting a new duration value. In some implementations, the user may have adjusted the duration 804 by adjusting the agenda timeline 620, e.g., by dragging the marker 702 for the agenda item 802 as shown in FIG. 7. The user may also have selected the segment of the agenda timeline 620 between the marker 702 and the marker 806 to indicate that the third agenda item is the agenda item intended for modification (and not the second agenda item having a duration between marker 702 and marker 808).

In response to the user adjustment of the duration of agenda item 802, the other agenda items not adjusted by the user can be automatically adjusted. In the example of FIG. 8, the duration 820 (e.g., displayed length) of the third agenda item segment on agenda timeline 620 is held constant at 10 minutes, since this duration was specified by the user. The other agenda item segments of the agenda timeline 620 were automatically determined in FIG. 6 and not specified by the user, and so these can be automatically adjusted based on specified rules, e.g., so that the durations of all the agenda items fit within the designated duration of the videoconference. In this example, these other agenda item segments are adjusted to be of equal duration to each other, as shown, and to fit within the videoconference duration, which is 30 minutes. The displayed agenda item durations 610 are also updated to this adjusted duration. Other implementations can adjust the durations of the other agenda items based on different rules. For example, if priorities are assigned to agenda items, then agenda items with highest priority can have their durations remain constant and not be reduced, or be reduced by a smaller amount than durations of agenda items having lower priority.

FIG. 9 shows user interface 400 of FIG. 4 after a new videoconference has been scheduled as shown in the examples of FIGS. 5-8. Videoconference schedule interface 402 includes videoconference list 406, in which scheduled videoconferences 408 are displayed. A new scheduled videoconference 902 is displayed in the list 406 with the scheduled videoconferences 408, e.g., where the list has an order sorted by starting time of the scheduled videoconferences. A user can select the link 904 to join the videoconference (e.g., after the current time is equal to or after the start time of the videoconference), or can select join control 420 after selecting the videoconference 902.

FIGS. 10-11 are diagrammatic illustrations of example videoconference display interfaces including one or more features described herein. Similarly labeled items across FIGS. 10-11 indicate similar parts and may not be described for each Figure.

FIG. 10 shows an example videoconference display interface 1000 displayed by a display device of a system, e.g., one or more display screens, display projector, etc. of a client device or server device as described above. Interface 1000 displays images and information communicated in a videoconference in which multiple participating devices are connected. For example, the displaying system can be a participant device used by a participant user of the videoconference.

Display interface 1000 displays a videoconference main view 1002 that displays videoconference content information. For example, the main view 1002 can display a stream or feed of data (e.g., multiple image(s) or video), e.g., a live feed depicting a participant user. In some examples, a participant user who is currently speaking is displayed in the main view 1002. The image or video of the participating user can be captured by a camera connected to the participant device used by the participant user, and the speech (or other audio) of the participant user can be captured by a microphone connected to the participant device used by the participant user. The feed can be transmitted over a network to the other participant devices connected to the videoconference session.

In additional examples, the main view 1002 can display other types of videoconference content information. For example, slides, documents, text, stored images and/or videos, animations, figures, or other types of presentation content information can be displayed. For example, a participant user can select a file having such data and select the videoconference interface 1000 to transmit the file data to the other participant devices in the videoconference. In some implementations, video depicting participant users is not transmitted to participant devices in the videoconference session, and other types of videoconference content information is transmitted. For example, audio data capturing participant users' speech can be transmitted, and slides, documents, or other videoconference data can be displayed, e.g., in main view 1002 displayed by the participant devices.

Videoconference interface 1000 also can include participant views 1004. The participant views 1004 can be streams or feeds of data that are displayed with smaller size than the main view 1002, as shown. Each participant view 1004 can display videoconference content information originating from a different participant user of the videoconference. For example, participant view 1004a can show a feed provided by the user of the interface 1000, e.g., a feed of live video captured by a camera connected to the participant device and depicting the participant user. Participant views 1004b, 1004c, and 1004d can be live feeds of video depicting the other participant users connected to the videoconference. In this example, the participant view 1004d is showing the same feed and participant user as the main view 1002, e.g., because that user is currently speaking as detected by microphone(s) at the associated participant device.

Various videoconference controls 1008 can be provided in the videoconference interface 1000. For example, controls can be provided to increase the size of the main view to fill the entire display screen, to disconnect from the videoconference session, to mute the audio transmitted in the videoconference from the user using interface 1000, to disable the video transmitted in the videoconference depicting the user using interface 1000 (e.g., thus causing participant view 1004a to show a static blank or default image), etc.

Videoconference interface 1000 can display agenda information 1010 related to an agenda associated with the videoconference. For example, the agenda information may have been stored and/or associated with the videoconference scheduling information in a videoconference record. In the example of FIG. 10, agenda information 1010 includes a graphical timeline 1012 including markers 1014 showing the starting points of various agenda items similarly to the timeline 620 shown in FIGS. 6-8. A user can move a pointer 1016 over the timeline 1012 (e.g., hover over the timeline), or otherwise select the timeline 1012, to display agenda information 1018 related to the agenda item indicated by the pointer 1016 or selection. For example, the pointer 1016 is pointing to the fourth agenda item, which has an identifier of “Conclusion” and a duration of 7 minutes as indicated by the agenda information 1018.

In some implementations, a current agenda item indicator 1020 can be displayed in association with the timeline 1012. For example, the indicator 1020 can indicate a point on the timeline representing the current progress of the videoconference through the agenda, e.g., how much of the agenda has transpired in the videoconference. In the example of FIG. 10, the indicator 1020 is positioned within the first agenda item and soon after the start of the videoconference session, indicating that the videoconference session has recently started.

The agenda information 1010 can also include a display of the current agenda item 1022 that is currently active in the videoconference, based on the current time and/or the amount of time from the start of the videoconference. For example, the current agenda item 1022 displays the identifier “Introduction” in the example of FIG. 10. The indicator 1020 can point to a segment of the timeline representing the current agenda item on the timeline 1012. The agenda information 1010 can also include a display of the next agenda item 1024 that will next be active in the videoconference, after the current agenda item 1022 has expired. In some implementations, a list of all the agenda items can be displayed, with the currently-active agenda item being highlighted or otherwise indicated (e.g., with a pointer or other indicator). Some implementations can display a parent agenda item and/or one or more child agenda items of an active agenda item, if such parent and child agenda items exist.

In some implementations, a participant user is able to edit the agenda, including one or more parameters of the agenda, for the videoconference during the videoconference session. For example, the participant user using interface 1000 can select the current agenda item indicator 1020 and can move (e.g., drag) the indicator 1020 to be displayed at a different position on the timeline 1012, or select the different position on the timeline directly, thus changing the current point of progress of the videoconference to a different point within the active agenda item, or to a point in a different agenda item of the agenda. In some examples, the user can provide such input indicating that the participant users have changed to and are focused on a different agenda item than the scheduled agenda item for the current time. This causes the display of the current and next agenda items 1022 and 1024 to be updated in the display interface 1000 based on the new position of the indicator 1020. In some implementations, in response to such a change of indicator 1020, the system can adjust the agenda items so that any agenda items that have not yet been active in the videoconference are positioned at the end of the videoconference, after the agenda item that was selected by the user. For example, such repositioned agenda items can retain their original order as much as possible (except agenda items having a greater priority can be positioned first after the active agenda item).

In some implementations, one or more other commands can be received based on user input (e.g., selection of controls displayed in the interface 1000) that change the current point of progress of the videoconference. For example, a forward skip button and/or a reverse skip button can be selected by user input to cause the current point of progress to skip forward to the next agenda item (or other later agenda item) or backward to a previous agenda item, respectively, relative to the active agenda item. Some commands or controls can cause the current point of progress to return to the beginning of the active agenda item, move to a different position within the active agenda item, move to the last agenda item of the agenda, or move to other selected agenda items. Other examples include commands or controls that cause the current point of progress to stop or pause at the active agenda item, such that the next agenda item (or other agenda item) is not made active during the videoconference until another command is received from an appropriate user to resume the agenda (e.g., input from the scheduling user or a participant user associated with the active agenda item).

In additional examples, the participant user using interface 1000 can select any of the markers 1014 of the timeline and move the marker to a new position, thereby adjusting the duration of the associated agenda items similarly as described for the agenda creation interface 602 of FIG. 7. The participant user can also edit any parameters of the agenda items by selecting the agenda control 1030, which can cause an agenda interface to be displayed (e.g., within interface 1000 or in a separate window or other portion of the display screen). For example, the agenda interface can be similar to the agenda creation interface described with respect to FIGS. 6-8.

FIG. 11 shows an example of the videoconference display interface 1000 at a further point of progress in the videoconference session of FIG. 10. In this example, the videoconference session has reached the second agenda item, as indicated by the current agenda item 1022 and by indicator 1020. The next agenda item is the third agenda item, and the identifier 1024 of the third agenda item is displayed. In addition, since the third agenda item has a participant user associated with it (as shown in FIGS. 7-8), an identifier 1102 of that participant user can be displayed next to the identifier 1024 of the third agenda item. Some implementations can display an image of the participant user as an identifier 1102, e.g., an image selected from the live video or image feed of that participant user in the current videoconference session or prior videoconference.

A system implementing or in communication with the videoconference can determine that the point of progress of the videoconference session is within a threshold time period of the next agenda item. In this example, the videoconference session has reached a threshold time period of two minutes before the next (third) agenda item (“Solution”). In response, a notification 1104 is displayed in the display interface 1000. The notification can indicate expiration of the current agenda item time period and/or can indicate the next scheduled agenda item will start. In this example, the notification indicates that the next agenda item is approaching within the threshold amount of time. Such notifications can, for example, allow participant users to determine easily if the videoconference session is tracking the scheduled agenda.

In some implementations, notification 1104 can include additional or different information. For example, the notification can indicate particular information or a particular participant user that will be presenting during the next agenda item. In some implementations, the notification can prompt whether the participant user wishes to extend the time period of the current agenda item, and by how much time. The participant user can input an amount of time to extend the current agenda item. In response, the system can adjust the remaining and following agenda items to stay within the designated duration of the videoconference similarly as described above.

In some implementations, notifications can be displayed indicating or related to the rate of progress of the videoconference session through the agenda items and/or associated videoconference content. For example, the videoconference system may determine the total videoconference content information that is intended to be presented during the videoconference. For example, the system can be provided the total set of slides, pages, images, or other portions of data to be presented during the videoconference. In some implementations, the scheduling user (or a participant user) can designate particular sections of the content data that correspond to particular agenda items of the agenda. The system can check how far the presentation of the videoconference data has progressed, e.g., by checking which slide, document heading, or other portion of the videoconference data has been presented (displayed or otherwise output to the participants of the videoconference). Based on the rate of presentation of the videoconference content information (e.g., determined by averaging the amount of time that each portion or section of the content data is displayed before the next portion or section is displayed), the system can determine (e.g., estimate) an amount of time to be used to present the videoconference content information corresponding to a particular agenda item (and/or the amount time to be used to present all the videoconference content information for the entire session).

In some implementations, the system can determine whether the rate of progress is fast or slow with respect to allocated time of the agenda, e.g., based on a threshold difference in progress rate through the videoconference content information vs. the agenda item (or videoconference) duration. For example, if there are 10 slides that correspond to the first agenda item, three slides have been presented (30% of total), and the videoconference session has reached halfway through the duration of the first agenda item (50% of total), then the system can determine the progress is slow based on the difference of 20% in rate of progress, e.g., using a threshold difference rate of progress of 10%.

In some implementations, the rate of presentation of the videoconference content information can be determined based on prior history specific to the participant user who will be presenting the information (if user consent has been obtained). For example, from past videoconferences it may be known by the system that a particular user presents slides very fast, e.g., 15 seconds per slide, compared to a different user who is slower, e.g., 30 seconds to a minute per slide. This information can be used in the estimation of the amount of time suitable to present one or more agenda items and/or videoconference content information during the videoconference. In some implementations, this prior history information can be weighted less the further that the current videoconference progresses, and/or removed from consideration at some point during the videoconference. The estimation of the amount of time for presentation can then be updated based on a measured rate of progress in the current videoconference. In another example, rate of presentation can be determined based on prior history specific to a group of two or more of the participant users of the scheduled videoconference. For example, if the same group of participant users in the scheduled videoconference were present in one or more prior videoconferences (or if a threshold number or threshold percentage of the participant users were present in the prior videoconferences), a stored rate of presentation determined for those prior videoconferences can be used to determine the rate of presentation of the current videoconference. In one example, an average of the rates of presentation from the prior videoconferences can be used as the estimated rate of presentation for the scheduled videoconference.

If the system determines that progress is fast or slow, then a notification (e.g., alert or warning) can be displayed indicating this status. The participant users can then adjust their rate of discussion or presentation to fit within the scheduled agenda.

In another example, the system can determine a percentage of content information (e.g., slides from a slide presentation or pages from a document) that have been so far presented (e.g., displayed), and an indication can be displayed of a rate of slides or pages presented per minute in the current videoconference and an estimate of the amount of time suitable to present the remaining content at the current rate.

Obtaining of videoconference content information is performed with the user's consent, e.g., via stored user preferences. The content information can be locally stored and accessible by the system implementing the videoconference, and/or can be remotely stored on one or more servers or client devices.

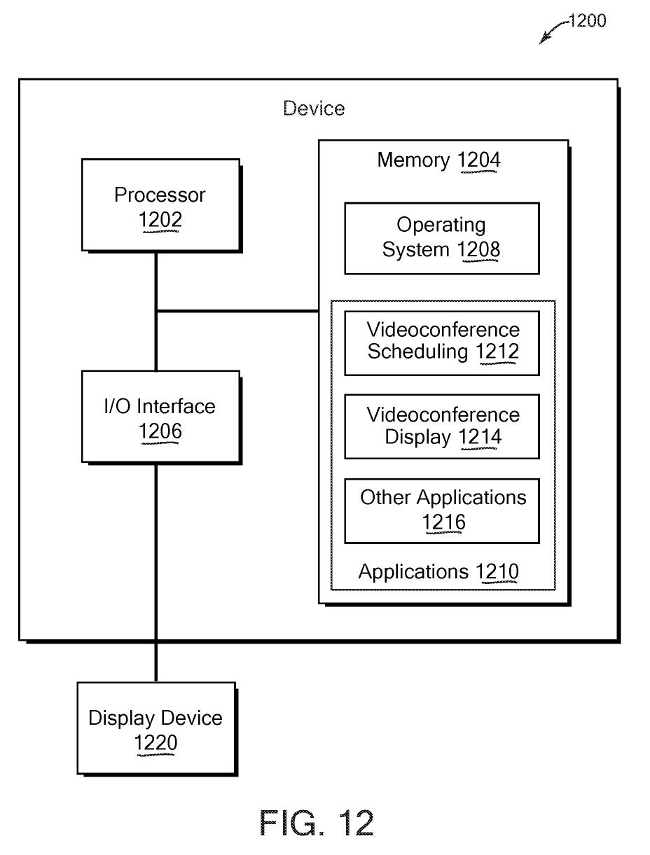

FIG. 12 is a block diagram of an example device 1200 which may be used to implement some implementations described herein. In one example, device 1200 may be used to implement a computer device that implements a server device, e.g., server device 104 of FIG. 1, and perform appropriate method implementations described herein. Device 1200 can be any suitable computer system, server, or other electronic or hardware device. For example, the device 1200 can be a mainframe computer, desktop computer, workstation, portable computer, or electronic device (portable device, cell phone, smart phone, tablet computer, television, TV set top box, personal digital assistant (PDA), media player, game device, wearable device, remote control, handheld game- or device-controller, etc.).

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 1200 includes a processor 1202, a memory 1204, and input/output (I/O) interface 1206. Processor 1202 can be one or more processors and/or processing circuits to execute program code and control basic operations of the device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in device 1200 for access by the processor 1202, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 1202 and/or integrated therewith. Memory 1204 can store software operating on the server device 1200 by the processor 1202, including an operating system 1208 and one or more applications 1210 such as a data display engine, web hosting engine, image display engine, notification engine, social networking engine, etc. In some implementations, the applications 1210 can include instructions that enable processor 1202 to perform functions described herein, e.g., some or all of the methods of FIGS. 2 and 3. For example, applications 1210 can include one or more videoconference scheduling applications 1212, including a program to receive user input and store a record for a defined videoconference. Applications 1210 can include one or more videoconference display applications 1214 including a program to display videoconference content information and feeds during a videoconference on a display device connected to the device 1200. One or more of the applications can, for example, provide a displayed user interface responsive to user input to display selectable options or controls, and data based on selected options. Other applications or engines 1216 can also or alternatively be included in applications 1210, e.g., image editing applications, media display applications, communication applications, web hosting engine or application, etc. One or more methods disclosed herein can operate in several environments and platforms, e.g., as a stand-alone computer program that can run on any type of computing device, as a web application having web pages, as a mobile application (“app”) run on a mobile computing device, etc.

Any of software in memory 1204 can alternatively be stored on any other suitable storage location or computer-readable medium. In addition, memory 1204 (and/or other connected storage device(s)) can store videoconference records, videoconference content information and parameters, agenda items and parameters, data structures, user preferences, and/or other instructions and data used in the features described herein. Memory 1204 and any other type of storage (magnetic disk, optical disk, magnetic tape, or other tangible media) can be considered “storage” or “storage devices.”

I/O interface 1206 can provide functions to enable interfacing the server device 1200 with other systems and devices. For example, network communication devices, storage devices (e.g., memory and/or database 106), and input/output devices can communicate via interface 1206. In some implementations, the I/O interface can connect to interface devices such as input devices (keyboard, pointing device, touchscreen, microphone, camera, scanner, etc.) and/or output devices (display device, speaker devices, printer, motor, etc.). Display device 1220 is one example of an output device that can be used to display content, e.g., video or images and/or a user interface of an output application as described herein. Display device 1220 can be connected to device 1200 via local connections (e.g., display bus) and/or via networked connections and can be any suitable display device, some examples of which are described below.

For ease of illustration, FIG. 12 shows one block for each of processor 1202, memory 1204, I/O interface 1206, and software blocks 1208 and 1210. These blocks may represent one or more processors or processing circuitries, operating systems, memories, I/O interfaces, applications, and/or software modules. In other implementations, server device 1200 may not have all of the components shown and/or may have other elements including other types of elements instead of, or in addition to, those shown herein. While server system 102 is described as performing blocks and operations as described in some implementations herein, any suitable component or combination of components of server system 102 or similar system, or any suitable processor or processors associated with such a system, may perform the blocks and operations described.

A client device can also implement and/or be used with one or more features described herein, e.g., client devices 120-126 shown in FIG. 1. Example client devices can include some similar components as the device 1200, such as processor(s) 1202, memory 1204, and I/O interface 1206. An operating system, software and applications suitable for the client device can be provided in memory and used by the processor, e.g., videoconference scheduling and display software, client group communication application software, etc. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device 1220, for example, can be connected to or included in device 1200 to display user interfaces and/or data as described herein, where such device can include any suitable display device such as an LCD, LED, or plasma display screen, CRT, television, monitor, touchscreen, 3-D display screen, or other visual display device. Some implementations can provide an audio output device, such as voice output or synthesis that speaks text.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

One or more systems and methods discussed herein do not require collection or usage of user personal information. In situations in which certain implementations discussed herein may collect or use personal information about users (e.g., user data, information about a user's social network, user's location and time, user's biometric information, user's activities and demographic information), users are provided with one or more opportunities to control whether the personal information is collected, whether the personal information is stored, whether the personal information is used, and how the information is collected about the user, stored and used. That is, the systems and methods discussed herein collect, store and/or use user personal information only upon receiving explicit authorization from the relevant users to do so. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed such as procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving, at a device, scheduling input associated with a videoconference, wherein the scheduling input includes a time for the videoconference and one or more identifiers of one or more participants for the videoconference;
in response to receiving the scheduling input, generating a record of the videoconference in storage;
determining an agenda for the videoconference including a plurality of agenda items, each agenda item associated with a respective time period of a plurality of time periods in the videoconference, wherein determining the agenda includes automatically determining at least one of the plurality of time periods;
detecting that the videoconference is in progress; and
in response to detecting that the videoconference is in progress, causing output during the videoconference on one or more participating user devices connected to the videoconference, the output based on at least one of the plurality of agenda items.

2. The method of claim 1 further comprising:
causing a user interface to be displayed on the device; and
receiving agenda input in the user interface from a user, the agenda input specifying at least one of the plurality of agenda items for the videoconference.

3. The method of claim 2 wherein the scheduling input specifies a time duration for the videoconference, and wherein determining the agenda includes:
dividing the time duration of the videoconference into the plurality of time periods, including determining an equal amount of time for each of the plurality of time periods within the time duration of the videoconference, wherein each agenda item is associated with a selected time period of the plurality of time periods.

4. The method of claim 2 wherein the scheduling input specifies a time duration for the videoconference, and further comprising:
receiving additional agenda input from the user adjusting a duration of at least one selected time period of the plurality of time periods associated with the plurality of agenda items; and
automatically determining other time periods exclusive of the at least one selected time period, such that the other time periods do not overlap with the at least one selected time period and the other time periods are within the time duration of the videoconference.

5. The method of claim 2 wherein the user interface is configured to receive user input rearranging a sequence of the plurality of agenda items.

6. The method of claim 2 further comprising:
receiving videoconference content information to be presented during the videoconference,
wherein automatically determining at least one of the plurality of time periods is based at least in part on the videoconference content information to be presented during the videoconference.

7. The method of claim 6 further comprising:
estimating an amount of time for presenting the videoconference content information during the videoconference based on an analysis of the videoconference content information; and
causing a display in the user interface of the amount of time.

8. The method of claim 2 wherein the plurality of agenda items include one or more suggested agenda items, wherein the at least one of the plurality of time periods is associated with at least one of the one or more suggested agenda items, and further comprising displaying the plurality of agenda items in the user interface.

9. The method of claim 8 wherein the one or more suggested agenda items are determined based on one of:
one or more prior agenda items used in one or more prior videoconferences in which the user participated; and
one or more participant users designated to participate in the videoconference.

10. The method of claim 1 further comprising determining one or more priority levels associated with one or more agenda items of the plurality of agenda items, wherein automatically determining at least one of the plurality of time periods includes determining an amount of time for the at least one of the plurality of time periods based on the one or more priority levels associated with the one or more agenda items.

11. The method of claim 10 wherein automatically determining at least one of the plurality of time periods includes determining a first amount of time for one or more time periods associated with one or more agenda items having a first priority level, and determining a second amount of time less than the first amount of time for one or more time periods associated with one or more agenda items having a second priority level lower than the first priority level.

12. The method of claim 1 further comprising:
providing a user selection control in a user interface;
receiving a selection of one or more selected participant users associated with one or more of the plurality of agenda items, wherein the selection is based on user input selecting the user selection control; and
sending a notification to the one or more selected participant users indicating the association of the one or more selected participant users with the one or more of the plurality of agenda items.

13. The method of claim 1 wherein the output during the videoconference includes display of the agenda, wherein causing output during the videoconference includes causing a display of an indicator that indicates a current point of progress in the agenda, and wherein the output during the videoconference includes one or more notifications of expiration of one or more of the plurality of time periods of the plurality of agenda items during the videoconference.

14. A system comprising:
a storage device; and
at least one processor configured to access the storage device, the at least one processor configured to perform operations comprising:
determining that a first device is connected to a videoconference as one of a plurality of participant devices connected to the videoconference over a network, wherein the first device provides a display of videoconference content information received over the network by the first device during the videoconference;
obtaining data specifying an agenda, wherein the agenda includes a plurality of agenda items in a specified sequence and a respective time period allocated to each of the plurality of agenda items during the videoconference;
causing display, by the first device, of at least a portion of the agenda during display of at least a portion of the videoconference content information; and
causing output by the first device during the videoconference of a notification associated with at least one of the plurality of agenda items at a time based on a time period associated with the at least one of the plurality of agenda items.

15. The system of claim 14 wherein the at least one processor is further configured to perform operations including:
causing display by the first device of an indicator that indicates a current progress point in the agenda for the videoconference, wherein the indicator indicates an indicated agenda item of the plurality of agenda items of the agenda;
receiving user input during the videoconference indicating to change the current progress point in the agenda from the indicated agenda item to a different one of the plurality of agenda items; and
causing a change of the display of the indicator to indicate the different one of the plurality of agenda items.

16. The system of claim 14 wherein the notification is output in response to a current time of the videoconference reaching a point in time that is within a threshold period of time before a start of a next agenda item after a current agenda item,
wherein the notification indicates at least one of:
expiration of an active agenda item during the videoconference; and
approach of the next agenda item during the videoconference.

17. The system of claim 14 wherein the at least the portion of the agenda includes a graphical timeline that graphically indicates the plurality of agenda items.

18. The system of claim 14 wherein the at least one processor is further configured to perform operations including:
receiving user input from a user of the first device to change one or more agenda items of the plurality of agenda items during the videoconference; and
causing an update to the agenda and the display of the agenda during the videoconference based on the user input, wherein the update is provided to the plurality of participant devices connected to the videoconference,
wherein causing the update to the agenda includes automatically adjusting one or more time periods of one or more of the plurality of agenda items not changed by the user input, such that the one or more of the plurality of agenda items not changed by the user input do not overlap the one or more agenda items of the plurality of agenda items changed by the user input.

19. The system of claim 14 wherein the at least one processor is further configured to perform operations including:
receiving and storing notes input by one or more users in the videoconference; and
in response to a disconnection of the videoconference, sending the notes to users participating in the videoconference, wherein the notes are organized based on one or more agenda items active during which the notes were input.

20. A non-transitory computer readable medium having stored thereon software instructions that, when executed by a processor, cause the processor to perform operations including:
receiving scheduling input from a device, the scheduling input associated with a videoconference, wherein the scheduling input includes a time for the videoconference and one or more identifiers of one or more participants for the videoconference;
in response to receiving the scheduling input, generating a record of the videoconference in storage;
determining an agenda for the videoconference including a plurality of agenda items, one or more of the plurality of agenda items associated with a respective time period in the videoconference;
detecting that the videoconference is in progress; and
in response to detecting that the videoconference is in progress, causing output during the videoconference on one or more participating user devices connected to the videoconference, the output indicating one or more active agenda items of the agenda and one or more upcoming agenda items of the agenda.
